(19) United States
(12) Patent Application Publication
(10) Pub. No.: US 2018/0270803 A1
(43) Pub. Date: Sep. 20, 2018

(54) METHOD FOR TRANSMITTING UPLINK DATA IN WIRELESS COMMUNICATION SYSTEM AND APPARATUS FOR METHOD

(71) Applicant: LG Electronics Inc., Seoul (KR)

(72) Inventors: Kyuhwan KWAK, Seoul (KR); Yunjung YI, Seoul (KR); Daesung HWANG, Seoul (KR)

(21) Appl. No.: 15/760,035

(22) PCT Filed: Sep. 26, 2016
(86) PCT No.: PCT/KR2016/010741

§ 371 Date: Mar. 14, 2018

Related U.S. Application Data
(60) Provisional application No. 62/232,471, filed on Sep. 25, 2015.
(60) Provisional application No. 62/236,159, filed on Oct. 2, 2015.

(51) Int. Cl. H04W 72/04; H04W 74/08; H04W 56/00

(52) U.S. Cl. CPC H04W 72/0406; H04W 56/001; H04W 74/08

(57) ABSTRACT

Disclosed is a method for transmitting uplink data in a wireless communication system, the method performed by an user equipment (UE) according to the present specification comprising: establishing synchronization with a base station; receiving, from the base station, control information associated with a contention-based uplink data transmission resource area; notifying the base station of the size of the uplink data to be transmitted; and transmitting the uplink data to the base station by means of the contention-based uplink data transmission resource area.

### CROSS-REFERENCE TO RELATED APPLICATIONS

This application is the National Stage filing under 35 U.S.C. 371 of International Application No. PCT/KR2016/010741, filed on Sep. 26, 2016, which claims the benefit of U.S. Provisional Application No. 62/232,471, filed on Sep. 25, 2015 and U.S. Provisional Application No. 62/236,159, filed on Oct. 02, 2015, the contents of which are all hereby incorporated by reference herein in their entirety.

### TECHNICAL FIELD

The present invention relates to a wireless communication system and, more particularly, to a method for transmitting uplink data in a wireless communication system and an apparatus supporting the same.

### BACKGROUND ART

Mobile communication systems have been developed to provide voice services while ensuring the activity of a user. However, the mobile communication systems have been expanded to their regions up to data services as well as voice. Today, the shortage of resources is caused due to an explosive increase of traffic, and more advanced mobile communication systems are required due to user's need for higher speed services.

Requirements for a next-generation mobile communication system basically include the acceptance of explosive data traffic, a significant increase of a transfer rate per user, the acceptance of the number of significantly increased connection devices, very low end-to-end latency, and high energy efficiency. To this end, research is carried out on various technologies, such as dual connectivity, massive Multiple Input Multiple Output (MIMO), in-band full duplex, Non-Orthogonal Multiple Access (NOMA), the support of a super wideband, and device networking.

### DISCLOSURE

### Technical Problem

An object of this specification is to provide a method of preventing a collision between the uplink data transmissions of UEs in a high-density UE environment through the allocation of a contention-based data transmission resource region and efficiently allocating resources to a plurality of UEs.

Furthermore, an object of this specification is to provide a method of allocating resources to a UE by taking into consideration a CP length in order to minimize interference in an eNB although it is out of synchronization.

Furthermore, an object of this specification is to provide a method of not allocating a resource for another UE to a resource neighboring a resource allocated to a UE that has not been synchronized in order to minimize interference in an eNB although it is out of synchronization.

Technical objects to be achieved by this specification are not limited to the aforementioned technical objects, and other technical objects not described above may be evidently understood by a person having ordinary skill in the art to which the present invention pertains from the following description.

### TECHNICAL SOLUTION

In this specification, a method of transmitting uplink data in a wireless communication system is performed by a UE and includes the steps of establishing synchronization with an eNB; receiving control information related to a contention-based uplink data transmission resource region from the eNB, the contention-based uplink data transmission resource region including one or more resource groups; notifying the eNB of the size of uplink data to be transmitted; and transmitting the uplink data to the eNB through the contention-based uplink data transmission resource region.

Furthermore, in this specification, the resource groups are resource groups allocated for each UE group based on a specific criterion.

Furthermore, in this specification, the specific criterion is at least one of the identity of the UE or the coverage class of the UE.

Furthermore, in this specification, the step of transmitting the uplink data comprises the steps of selecting any one of the resource groups and transmitting the uplink data to the eNB through the selected resource group.

Furthermore, in this specification, the step of selecting the any one resource group comprises selecting any one resource group by taking into consideration the size of the uplink data to be transmitted.

Furthermore, in this specification, the step of notifying the size of uplink data to be transmitted includes the step of transmitting a root-sequence mapped to an index indicative of the size of the uplink data to be transmitted to the eNB.

Furthermore, in this specification, the root-sequence is transmitted prior to the uplink data transmission.

Furthermore, in this specification, the root-sequence or the uplink data is scrambled by the index.

Furthermore, in this specification, the step of notifying the size of uplink data to be transmitted is performed along with the transmission of the uplink data.

Furthermore, in this specification, the uplink data includes a first segment and a second segment, and the size of the uplink data to be transmitted is included in the first segment.

Furthermore, in this specification, the one or more resource groups are allocated dynamically or semi-statically.

Furthermore, the method of transmitting uplink data according to this specification further includes the step of receiving acknowledgement (ACK) or non-acknowledgement (NACK) for the uplink data from the eNB, wherein the ACK or the NACK is received for each resource group.

Furthermore, the method of transmitting uplink data according to this specification further includes the step of switching to an idle state, wherein a cell-radio network temporary identifier (C-RNTI) allocated by the eNB is not released.

Furthermore, in this specification, the resource groups are classified according to a cyclic prefix (CP) length, and if the UE is not synchronized with the eNB, a resource group belonging to the resource groups and corresponding to a long CP length is selected.

Furthermore, in this specification, if the UE is not synchronized with the eNB, a resource for another UE is not allocated to a neighboring resource of the selected resource group.

Furthermore, in this specification, the contention-based uplink data transmission resource region is a narrowband including a plurality of subcarriers having specific subcarrier spacing.

Furthermore, in this specification, the control information is received from the eNB through at least one of a group-RNTI and a C-RNTI.

Furthermore, in this specification, a UE for transmitting uplink data in a wireless communication system includes a radio frequency (RF) unit for transmitting or receiving a radio signal; and a processor functionally connected to the RF unit, the processor performs control so that synchronization is established with an eNB, control information related to a contention-based uplink data transmission resource region is received from the eNB, the contention-based uplink data transmission resource region including one or more resource groups, the eNB is notified of the size of uplink data to be transmitted, and the uplink data is transmitted to the eNB through the contention-based uplink data transmission resource region.

### Advantageous Effects

This specification has effects in that it can prevent a collision between the uplink data transmissions of UEs in a high-density UE environment by allocating a contention-based data transmission region and can efficiently allocate resources to a plurality of UEs.

Furthermore, this specification has an effect in that it can minimize interference in an eNB although it is out of synchronization by allocating a resource to a UE by taking into consideration a CP length.

Furthermore, this specification has an effect in that it can minimize interference in an eNB by not allocating a resource for another UE to a resource neighboring a resource allocated to a UE that has not been synchronized.

Effects which may be obtained by this specification are not limited to the aforementioned effects, and other technical effects not described above may be evidently understood by a person having ordinary skill in the art to which the present invention pertains from the following description.

### DESCRIPTION OF DRAWINGS

The accompanying drawings, which are included herein as a part of a description in order to help understanding of the present invention, provide embodiments of the present invention, and describe the technical features of the present invention with the description below.

FIG. 1 illustrates a structure a radio frame in a wireless communication system to which the present invention can be applied.

FIG. 2 is a diagram illustrating a resource grid for one downlink slot in the wireless communication system to which the present invention can be applied.

FIG. 3 illustrates a structure of a downlink subframe in the wireless communication system to which the present invention can be applied.

FIG. 4 illustrates a structure of an uplink subframe in the wireless communication system to which the present invention can be applied.

FIG. 5 illustrates one example of a type in which PUCCH formats are mapped to a PUCCH region of an uplink physical resource block in the wireless communication system to which the present invention can be applied.

FIG. 6 illustrates a structure of a CQI channel in the case of a general CP in the wireless communication system to which the present invention can be applied.

FIG. 7 shows the structure of an ACK/NACK channel in the case of a normal CP in a wireless communication system to which the present invention may be applied.

FIG. 8 shows an example in which five SC-FDMA symbols are generated and transmitted during one slot in a wireless communication system to which the present invention may be applied.

FIG. 9 shows an example of component carriers and carrier aggregations in a wireless communication system to which the present invention may be applied.

FIG. 10 shows an example of the structure of a subframe according to cross-carrier scheduling in a wireless communication system to which the present invention may be applied.

FIG. 11 shows an example of the transport channel processing of an UL-SCH in a wireless communication system to which the present invention may be applied.

FIG. 12 shows an example of the signal processing process of an uplink shared channel, that is, a transport channel, in a wireless communication system to which the present invention may be applied.

FIG. 13 illustrates a reference signal pattern mapped to a downlink resource block pair in a wireless communication system to which the present invention may be applied.

FIG. 14 illustrates an uplink subframe including a sounding reference signal symbol in a wireless communication system to which the present invention may be applied.

FIG. 15 is a diagram showing an example in which a legacy PDCCH, a PDSCH and an E-PDCCH are multiplexed.

FIG. 16 is a diagram showing an example of uplink numerology in a time domain.

FIG. 17 is a diagram showing an example of time units for the uplink of NB-LTE based on 2.5 kHz subcarrier spacing.

FIG. 18 is a diagram showing an example of the operating system of an NB LTE system to which a method proposed by this specification may be applied.

FIG. 19 is a diagram showing an example of a dynamic resource allocation method proposed by this specification.

FIG. 20 is a diagram showing an example of a semi-persistent resource allocation method proposed by this specification.

FIG. 21 is a diagram showing an example of resource pool allocation for a specific UE group and detailed resource group allocation proposed by this specification.

FIG. 22 is a diagram showing an example of a UE group classification according to a CP length and a resource pool configuration for each group proposed by this specification.

FIG. 23 is a diagram showing an example in which a resource neighboring a resource used by a UE group whose TA is incorrect is reserved, which is proposed by this specification.

FIG. 24 is a flowchart showing an example of an uplink data transmission method of a UE proposed by this specification.

FIG. 25 shows an example of an internal block diagram of a wireless communication apparatus to which the methods proposed by this specification may be applied.

### MODE FOR INVENTION

Hereinafter, preferred embodiments of the present invention will be described in detail with reference to the accompanying drawings. A detailed description to be disclosed below together with the accompanying drawing is to describe embodiments of the present invention and not to describe a unique embodiment for carrying out the present invention. The detailed description below includes details in order to provide a complete understanding. However, those skilled in the art know that the present invention can be carried out without the details.

In some cases, in order to prevent a concept of the present invention from being ambiguous, known structures and devices may be omitted or may be illustrated in a block diagram format based on core function of each structure and device.

In the specification, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the present invention and the use of the specific terms may be modified into other forms within the scope without departing from the technical spirit of the present invention.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as global system for mobile communications (GSM)/general packet radio service(GPRS)/enhanced data rates for GSM Evolution (EDGE). The OFDMA may be implemented as radio technology such as IEEE 802.11 (Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the present invention may be based on standard documents disclosed in at least one of IEEE 802, 3GPP, and 3GPP2 which are the wireless access systems. That is, steps or parts which are not described to definitely show the technical spirit of the present invention among the embodiments of the present invention may be based on the documents. Further, all terms disclosed in the document may be described by the standard document.

3GPP LTE/LTE-A is primarily described for clear description, but technical features of the present invention are not limited thereto.

General System

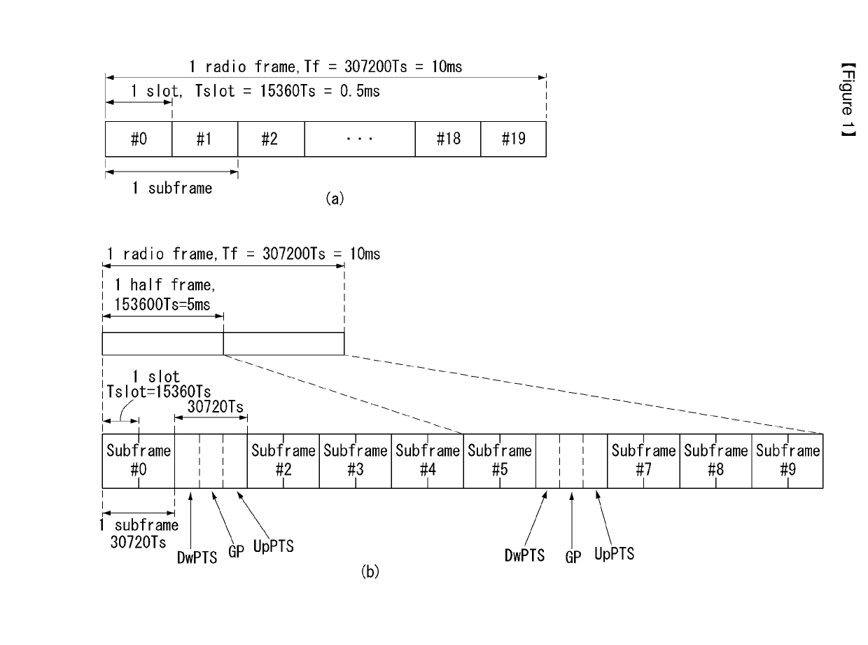

FIG. 1 illustrates a structure a radio frame in a wireless communication system to which the present invention can be applied.

In 3GPP LTE/LTE-A, radio frame structure type 1 may be applied to frequency division duplex (FDD) and radio frame structure type 2 may be applied to time division duplex (TDD) are supported.

FIG. 1(a) exemplifies radio frame structure type 1. The radio frame is constituted by 10 subframes. One subframe is constituted by 2 slots in a time domain. A time required to transmit one subframe is referred to as a transmissions time interval (TTI). For example, the length of one subframe may be 1 ms and the length of one slot may be 0.5 ms.

One slot includes a plurality of orthogonal frequency division multiplexing (OFDM) symbols in the time domain and includes multiple resource blocks (RBs) in a frequency domain. In 3GPP LTE, since OFDMA is used in downlink, the OFDM symbol is used to express one symbol period. The OFDM symbol may be one SC-FDMA symbol or symbol period. The resource block is a resource allocation wise and includes a plurality of consecutive subcarriers in one slot.

FIG. 1(b) illustrates frame structure type 2. Radio frame type 2 is constituted by 2 half frames, each half frame is constituted by 5 subframes, a downlink pilot time slot (DwPTS), a guard period (GP), and an uplink pilot time slot (UpPTS), and one subframe among them is constituted by 2 slots. The DwPTS is used for initial cell discovery, synchronization, or channel estimation in a terminal. The UpPTS is used for channel estimation in a base station and to match uplink transmission synchronization of the terminal. The guard period is a period for removing interference which occurs in uplink due to multi-path delay of a downlink signal between the uplink and the downlink.

In frame structure type 2 of a TDD system, an uplink-downlink configuration is a rule indicating whether the uplink and the downlink are allocated (alternatively, reserved) with respect to all subframes. Table 1 shows he uplink-downlink configuration.

TABLE 1

| | Downlink- | | | | | | | | | | |
|---|---|---|---|---|---|---|---|---|---|---|---|
| | to- | | | | | | | | | | |
| | Uplink | | | | | | | | | | |
| Uplink- | Switch- | | | | | | | | | | |
| Downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Referring to Table 1, for each subframe of the radio frame, ‘ID’ represents a subframe for downlink transmission, ‘U’ represents a subframe for uplink transmission, and ‘S’ represents a special subframe constituted by three fields such as the DwPTS, the GP, and the UpPTS. The uplink-downlink configuration may be divided into 7 configurations and the positions and/or the numbers of the downlink subframe, the special subframe, and the uplink subframe may vary for each configuration.

A time when the downlink is switched to the uplink or a time when the uplink is switched to the downlink is referred to as a switching point. Switch-point periodicity means a period in which an aspect of the uplink subframe and the downlink subframe are switched is similarly repeated and both 5 ms or 10 ms are supported. When the period of the downlink-uplink switching point is 5 ms, the special subframe S is present for each half-frame and when the period of the downlink-uplink switching point is 5 ms, the special subframe S is present only in a first half-frame.

In all configurations, subframes #0 and #5 and the DwPTS are intervals only the downlink transmission. The UpPTS and a subframe just subsequently to the subframe are continuously intervals for the uplink transmission.

The uplink-downlink configuration may be known by both the base station and the terminal as system information. The base station transmits only an index of configuration information whenever the uplink-downlink configuration information is changed to announce a change of an uplink-downlink allocation state of the radio frame to the terminal. Further, the configuration information as a kind of downlink control information may be transmitted through a physical downlink control channel (PDCCH) similarly to other scheduling information and may be commonly transmitted to all terminals in a cell through a broadcast channel as broadcasting information.

The structure of the radio frame is just one example and the number subcarriers included in the radio frame or the number of slots included in the subframe and the number of OFDM symbols included in the slot may be variously changed.

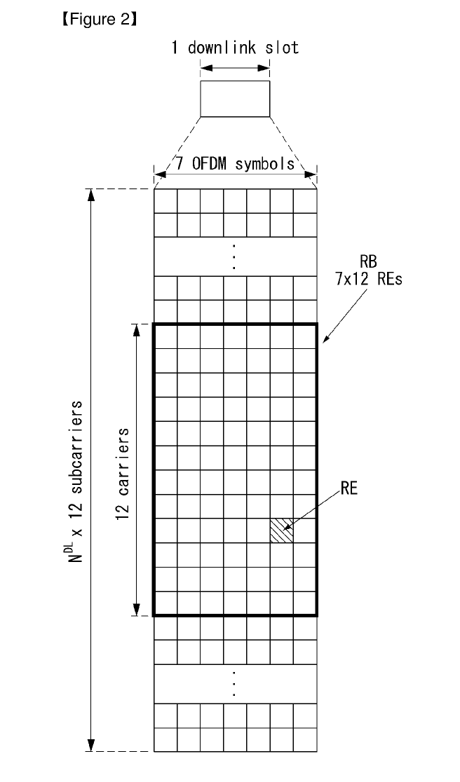

FIG. 2 is a diagram illustrating a resource grid for one downlink slot in the wireless communication system to which the present invention can be applied.

Referring to FIG. 2, one downlink slot includes the plurality of OFDM symbols in the time domain. Herein, it is exemplarily described that one downlink slot includes 7 OFDM symbols and one resource block includes 12 subcarriers in the frequency domain, but the present invention is not limited thereto.

Each element on the resource grid is referred to as a resource element and one resource block includes 12×7 resource elements. The number of resource blocks included in the downlink slot, NDL is subordinated to a downlink transmission bandwidth.

A structure of the uplink slot may be the same as that of the downlink slot.

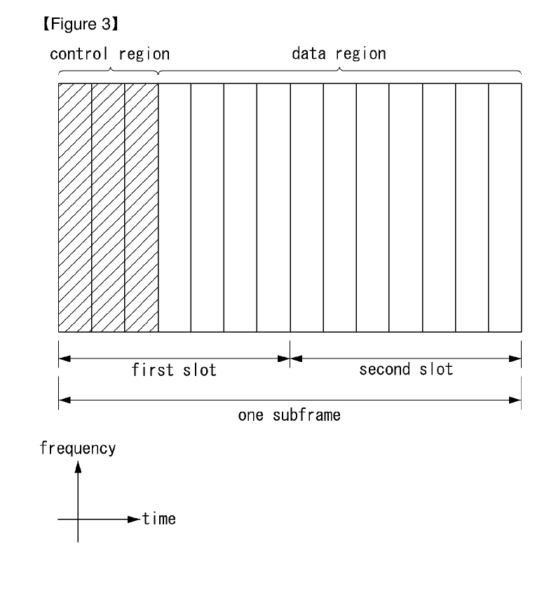

FIG. 3 illustrates a structure of a downlink subframe in the wireless communication system to which the present invention can be applied.

Referring to FIG. 3, a maximum of three former OFDM symbols in the first slot of the subframe are a control region to which control channels are allocated and residual OFDM symbols is a data region to which a physical downlink shared channel (PDSCH) is allocated. Examples of the downlink control channel used in the 3GPP LTE include a physical control format indicator channel (PCFICH), a physical downlink control channel (PDCCH), a physical hybrid-ARQ indicator channel (PHICH), and the like.

The PFCICH is transmitted in the first OFDM symbol of the subframe and transports information on the number (that is, the size of the control region) of OFDM symbols used for transmitting the control channels in the subframe. The PHICH which is a response channel to the uplink transports an acknowledgement (ACK)/not-acknowledgement (NACK) signal for a hybrid automatic repeat request (HARQ). Control information transmitted through a PDCCH is referred to as downlink control information (DCI). The downlink control information includes uplink resource allocation information, downlink resource allocation information, or an uplink transmission (Tx) power control command for a predetermined terminal group.

The PDCCH may transport a resource allocation and transmission format (also referred to as a downlink grant) of a downlink shared channel (DL-SCH), resource allocation information (also referred to as an uplink grant) of an uplink shared channel (UL-SCH), paging information in a paging channel (PCH), system information in the DL-SCH, resource allocation for an upper-layer control message such as a random access response transmitted in the PDSCH, an aggregation of transmission power control commands for individual terminals in the predetermined terminal group, a voice over IP (VoIP). A plurality of PDCCHs may be transmitted in the control region and the terminal may monitor the plurality of PDCCHs. The PDCCH is constituted by one or an aggregate of a plurality of continuous control channel elements (CCEs). The CCE is a logical allocation wise used to provide a coding rate depending on a state of a radio channel to the PDCCH. The CCEs correspond to a plurality of resource element groups. A format of the PDCCH and a bit number of usable PDCCH are determined according to an association between the number of CCEs and the coding rate provided by the CCEs.

The base station determines the PDCCH format according to the DCI to be transmitted and attaches the control information to a cyclic redundancy check (CRC) to the control information. The CRC is masked with a unique identifier (referred to as a radio network temporary identifier (RNTI)) according to an owner or a purpose of the PDCCH. In the case of a PDCCH for a specific terminal, the unique identifier of the terminal, for example, a cell-RNTI (C-RNTI) may be masked with the CRC. Alternatively, in the case of a PDCCH for the paging message, a paging indication identifier, for example, the CRC may be masked with a paging-RNTI (P-RNTI). In the case of a PDCCH for the system information, in more detail, a system information block (SIB), the CRC may be masked with a system information identifier, that is, a system information (SI)-RNTI. The CRC may be masked with a random access (RA)-RNTI in order to indicate the random access response which is a response to transmission of a random access preamble.

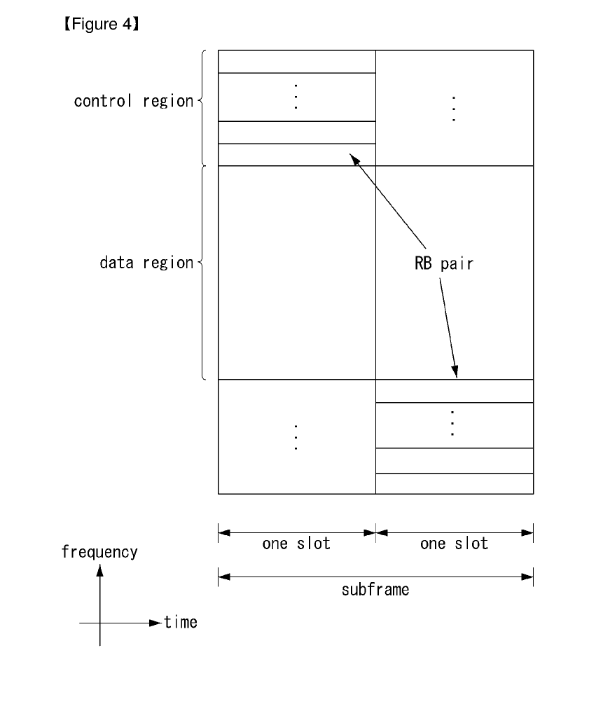

FIG. 4 illustrates a structure of an uplink subframe in the wireless communication system to which the present invention can be applied.

Referring to FIG. 4, the uplink subframe may be divided into the control region and the data region in a frequency domain. A physical uplink control channel (PUCCH) transporting uplink control information is allocated to the control region. A physical uplink shared channel (PUSCH) transporting user data is allocated to the data region. One terminal does not simultaneously transmit the PUCCH and the PUSCH in order to maintain a single carrier characteristic.

A resource block (RB) pair in the subframe is allocated to the PUCCH for one terminal. RBs included in the RB pair occupy different subcarriers in two slots, respectively. The RB pair allocated to the PUCCH frequency-hops in a slot boundary.

Physical Uplink Control Channel (PUCCH)

The uplink control information (UCI) transmitted through the PUCCH may include a scheduling request (SR), HARQ ACK/NACK information, and downlink channel measurement information.

The HARQ ACK/NACK information may be generated according to a downlink data packet on the PDSCH is successfully decoded. In the existing wireless communication system, 1 bit is transmitted as ACK/NACK information with respect to downlink single codeword transmission and 2 bits are transmitted as the ACK/NACK information with respect to downlink 2-codeword transmission.

The channel measurement information which designates feedback information associated with a multiple input multiple output (MIMO) technique may include a channel quality indicator (CQI), a precoding matrix index (PMI), and a rank indicator (RI). The channel measurement information may also be collectively expressed as the CQI.

20 bits may be used per subframe for transmitting the CQI.

The PUCCH may be modulated by using binary phase shift keying (BPSK) and quadrature phase shift keying (QPSK) techniques. Control information of a plurality of terminals may be transmitted through the PUCCH and when code division multiplexing (CDM) is performed to distinguish signals of the respective terminals, a constant amplitude zero autocorrelation (CAZAC) sequence having a length of 12 is primary used. Since the CAZAC sequence has a characteristic to maintain a predetermined amplitude in the time domain and the frequency domain, the CAZAC sequence has a property suitable for increasing coverage by decreasing a peak-to-average power ratio (PAPR) or cubic metric (CM) of the terminal. Further, the ACK/NACK information for downlink data transmission performed through the PUCCH is covered by using an orthogonal sequence or an orthogonal cover (OC).

Further, the control information transmitted on the PUCCH may be distinguished by using a cyclically shifted sequence having different cyclic shift (CS) values. The cyclically shifted sequence may be generated by cyclically shifting a base sequence by a specific cyclic shift (CS) amount. The specific CS amount is indicated by the cyclic shift (CS) index. The number of usable cyclic shifts may vary depending on delay spread of the channel. Various types of sequences may be used as the base sequence the CAZAC sequence is one example of the corresponding sequence.

Further, the amount of control information which the terminal may transmit in one subframe may be determined according to the number (that is, SC-FDMA symbols other an SC-FDMA symbol used for transmitting a reference signal (RS) for coherent detection of the PUCCH) of SC-FDMA symbols which are usable for transmitting the control information.

In the 3GPP LTE system, the PUCCH is defined as a total of 7 different formats according to the transmitted control information, a modulation technique, the amount of control information, and the like and an attribute of the uplink control information (UCI) transmitted according to each PUCCH format may be summarized as shown in Table 2 given below.

TABLE 2

| PUCCH | |
|---|---|
| Format | Uplink Control Information(UCI) |
| Format 1 | Scheduling Request(SR)(unmodulated waveform) |
| Format 1a | 1-bit HARQ ACK/NACK with/without SR |
| Format 1b | 2-bit HARQ ACK/NACK with/without SR |
| Format 2 | CQI (20 coded bits) |
| Format 2 | CQI and 1- or 2-bit HARQ ACK/NACK (20 bits) for |
| | extended CP only |
| Format 2a | CQI and 1-bit HARQ ACK/NACK (20 + 1 coded bits) |
| Format 2b | CQI and 2-bit HARQ ACK/NACK (20 + 2 coded bits) |

The PUCCH format 1 is used for transmitting only the SR. A waveform which is not modulated is adopted in the case of transmitting only the SR and this will be described below in detail.

The PUCCH format 1a or 1b is used for transmitting the HARQ ACK/NACK. PUCCH format 1a or 1b may be used when only the HARQ ACK/NACK is transmitted in a predetermined subframe. Alternatively, the HARQ ACK/NACK and the SR may be transmitted in the same subframe by using the PUCCH format 1a or 1b.

The PUCCH format 2 is used for transmitting the CQI and PUCCH format 2a or 2b is used for transmitting the CQI and the HARQ ACK/NACK.

In the case of an extended CP, the PUCCH format 2 may be transmitted for transmitting the CQI and the HARQ ACK/NACK.

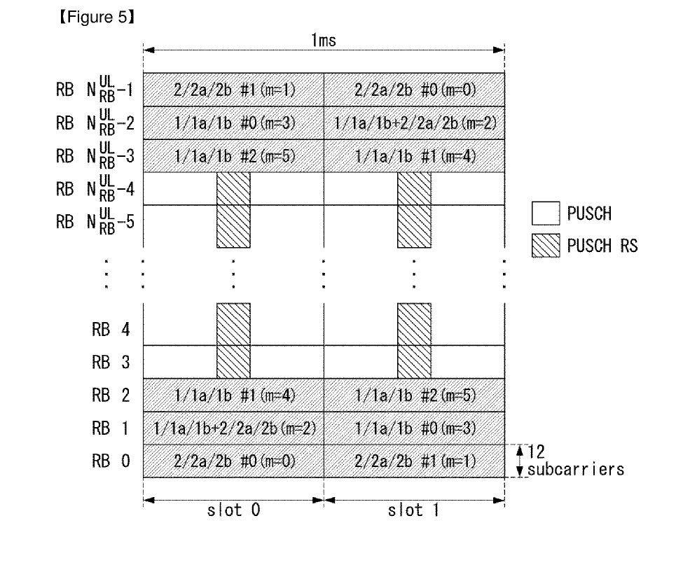

FIG. 5 illustrates one example of a type in which PUCCH formats are mapped to a PUCCH region of an uplink physical resource block in the wireless communication system to which the present invention can be applied.

In FIG. 5, N_{RB}^{UL} represents the number of resource blocks in the uplink and 0, 1, . . . , N_{RB}^{UL}−1 mean numbers of physical resource blocks. Basically, the PUCCH is mapped to both edges of an uplink frequency block. As illustrated in FIG. 5, PUCCH format 2/2a/2b is mapped to a PUCCH region expressed as m=0, 1 and this may be expressed in such a manner that PUCCH format 2/2a/2b is mapped to resource blocks positioned at a band edge. Further, both PUCCH format 2/2a/2b and PUCCH format 1/1a/1b may be interchangeably mapped to a PUCCH region expressed as m=2. Next, PUCCH format 1/1a/1b may be mapped to a PUCCH region expressed as m=3, 4, and 5. The number (N_{RB}⁽²⁾) of PUCCH RBs which are usable by PUCCH format 2/2a/2b may be indicated to terminals in the cell by broadcasting signaling.

The PUCCH formats 2/2a/2b are described. The PUCCH formats 2/2a/2b are control channels for transmitting channel measurement feedback (CQI, PMI, and RI).

The reporting period of the channel measurement feedbacks (hereinafter, collectively expressed as CQI information) and a frequency wise (alternatively, a frequency resolution) to be measured may be controlled by the base station. In the time domain, periodic and aperiodic CQI reporting may be supported. PUCCH format 2 may be used for only the periodic reporting and the PUSCH may be used for aperiodic reporting. In the case of the aperiodic reporting, the base station may instruct the terminal to transmit a scheduling resource loaded with individual CQI reporting for the uplink data transmission.

FIG. 6 illustrates a structure of a CQI channel in the case of a general CP in the wireless communication system to which the present invention can be applied.

In SC-FDMA symbols 0 to 6 of one slot, SC-FDMA symbols 1 and 5 (second and sixth symbols) may be used for transmitting a demodulation reference signal and the CQI information may be transmitted in the residual SC-FDMA symbols. Meanwhile, in the case of the extended CP, one SC-FDMA symbol (SC-FDMA symbol 3) is used for transmitting the DMRS.

In PUCCH format 2/2a/2b, modulation by the CAZAC sequence is supported and the CAZAC sequence having the length of 12 is multiplied by a QPSK-modulated symbol. The cyclic shift (CS) of the sequence is changed between the symbol and the slot. The orthogonal covering is used with respect to the DMRS.

The reference signal (DMRS) is loaded on two SC-FDMA symbols separated from each other by 3 SC-FDMA symbols among 7 SC-FDMA symbols included in one slot and the CQI information is loaded on 5 residual SC-FDMA symbols. Two RSs are used in one slot in order to support a high-speed terminal. Further, the respective terminals are distinguished by using the CS sequence. CQI information symbols are modulated and transferred to all SC-FDMA symbols and the SC-FDMA symbol is constituted by one sequence. That is, the terminal modulates and transmits the CQI to each sequence.

The number of symbols which may be transmitted to one TTI is 10 and modulation of the CQI information is determined up to QPSK. When QPSK mapping is used for the SC-FDMA symbol, since a CQI value of 2 bits may be loaded, a CQI value of 10 bits may be loaded on one slot. Therefore, a CQI value of a maximum of 20 bits may be loaded on one subframe. A frequency domain spread code is used for spreading the CQI information in the frequency domain.

The CAZAC sequence (e.g., ZC sequence) having the length of 12 may be used as the frequency domain spread code. CAZAC sequences having different CS values may be applied to the respective control channels to be distinguished from each other. IFFT is performed with respect to the CQI information in which the frequency domain is spread.

12 different terminals may be orthogonally multiplexed on the same PUCCH RB by a cyclic shift having 12 equivalent intervals. In the case of a general CP, a DMRS sequence on SC-FDMA symbol 1 and 5 (on SC-FDMA symbol 3 in the case of the extended CP) is similar to a CQI signal sequence on the frequency domain, but the modulation of the CQI information is not adopted.

The terminal may be semi-statically configured by upper-layer signaling so as to periodically report different CQI, PMI, and RI types on PUCCH resources indicated as PUCCH resource indexes (n_{PUCCH}^{(1,\tilde{p})}, n_{PUCCH}^{(2,\tilde{p})}, and n_{PUCCH}^{(3,\tilde{p})}). Herein, the PUCCH resource index (n_{PUCCH}^{(2,\tilde{p})}) is information indicating the PUCCH region used for PUCCH format 2/2a/2b and a CS value to be used.

PUCCH Channel Structure

The PUCCH formats 1a and 1b are described.

In the PUCCH formats 1a and 1b, the CAZAC sequence having the length of 12 is multiplied by a symbol modulated using a BPSK or QPSK modulation scheme. For example, a result acquired by multiplying a modulated symbol d(0) by a CAZAC sequence r(n) (n=0, 1, 2, . . . , N−1) having a length of N becomes y(0), y(1), y(2), . . . , y(N−1). y(0), . . . , y(N−1) symbols may be designated as a block of symbols. The modulated symbol is multiplied by the CAZAC sequence and thereafter, the block-wise spread using the orthogonal sequence is adopted.

A Hadamard sequence having a length of 4 is used with respect to general ACK/NACK information and a discrete Fourier transform (DFT) sequence having a length of 3 is used with respect to the ACK/NACK information and the reference signal.

The Hadamard sequence having the length of 2 is used with respect to the reference signal in the case of the extended CP.

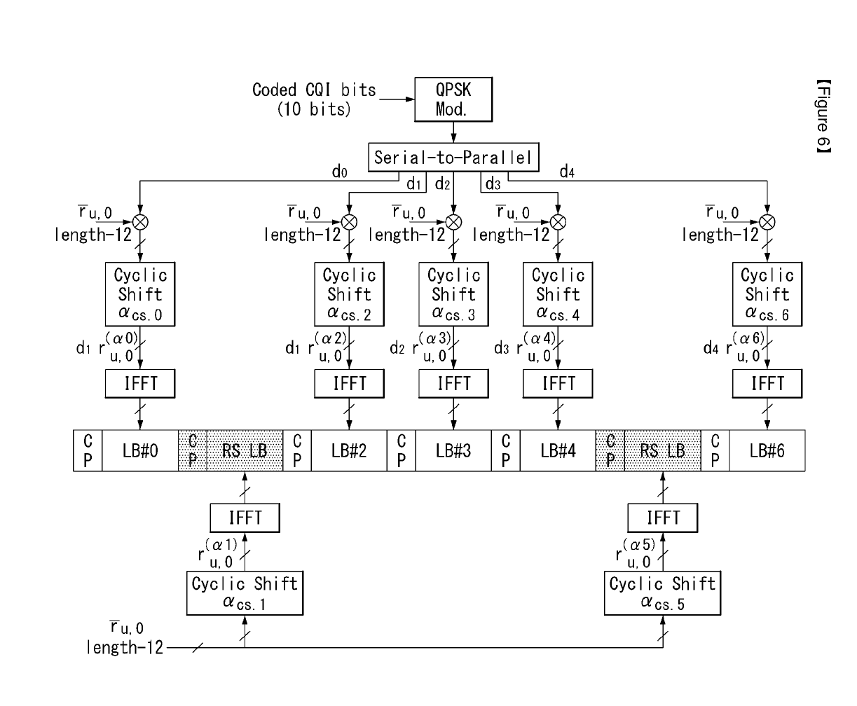

FIG. 7 shows the structure of an ACK/NACK channel in the case of a normal CP in a wireless communication system to which the present invention may be applied.

FIG. 7 illustrates a PUCCH channel structure for HARQ ACK/NACK transmission without a CQI.

A reference signal (RS) is carried on three contiguous SC-FDMA symbols that belong to seven SC-FDMA symbols included in one slot and that are located in the middle part, and an ACK/NACK signal is carried on the remaining four SC-FDMA symbols.

Meanwhile, in the case of an extended CP, an RS may be carried on two contiguous symbols in the middle part. The number of symbols and position used for an RS may be different depending on a control channel, and the number of symbols and position used for an ACK/NACK signal associated therewith may also be changed depending on the number of symbols and position used for an RS.

Acknowledgement information (the state in which it has not been scrambled) of 1 bit and 2 bits may be expressed as one HARQ ACK/NACK modulation symbol using each BPSK and QPSK modulation scheme. Acknowledgement (ACK) may be encoded into “1”, and non-acknowledgement (NACK) may be encoded into “0.”

When a control signal is transmitted within an allocated band, 2-dimension spreading is applied to increase the multiplexing capacity. That is, in order to increase the number of UEs or the number of control channels that may be multiplexed, frequency region spreading and time region spreading are applied at the same time.

In order to spread an ACK/NACK signal in the frequency domain, a frequency region sequence is used as a base sequence. A Zadoff-Chu (ZC) sequence, that is, one of CAZAC sequences, may be used as the frequency region sequence. For example, the multiplexing of different UEs or different control channels may be applied by applying different cyclic shifts (CS) to the ZC sequence, that is, a base sequence. The number of CS resources supported in an SC-FDMA symbol for PUCCH RBs for HARQ ACK/NACK transmission is configured by a cell-specific high-layer signaling parameter Δ_{shift}^{PUCCH}.

An ACK/NACK signal subjected to frequency region spreading is spread in the time domain using orthogonal spreading code. A Walsh-Hadamard sequence or a DFT sequence may be used as the orthogonal spreading code. For example, the ACK/NACK signal may be spread using an orthogonal sequence w0, w1, w2, w3 of a length 4 with respect to 4 symbols. Furthermore, an RS is spread through an orthogonal sequence of a length 3 or a length 2. This is called orthogonal covering (OC).

A plurality of UEs may be multiplexed according to a code division multiplexing (CDM) scheme using CS resources in the frequency region and OC resources in the time domain. That is, ACK/NACK information and RSs of a large number of UEs on the same PUCCH RB may be multiplexed.

The number of spreading codes supported with respect to ACK/NACK information is limited by the number of RS symbols with respect to time region spreading CDM. That is, since the number of RS transmission SC-FDMA symbols is smaller than the number of ACK/NACK information transmission SC-FDMA symbols, and thus the multiplexing capacity of an RS becomes less than the multiplexing capacity of ACK/NACK information.

For example, in the case of a normal CP, ACK/NACK information may be transmitted in four symbols. Not four orthogonal spreading codes, but three orthogonal spreading codes are used for the ACK/NACK information. The reason for this is that only three orthogonal spreading codes may be used for an RS because the number of RS transmission symbols is limited to 3.

In the case where the three symbols of one slot are used for RS transmission and four symbols thereof are used for ACK/NACK information transmission in a subframe of a normal CP, for example, if six cyclic shifts (CSs) in the frequency domain and three orthogonal covering (OC) resources in the time domain can be used, HARQ acknowledgement from a total of 18 different UEs may be multiplexed within one PUCCH RB. In the case where the two symbols of one slot are used for RS transmission and four symbols thereof are used for ACK/NACK information transmission in a subframe of an extended CP, for example, if six cyclic shifts (CSs) in the frequency domain and two orthogonal covering (OC) resources in the time domain can be used, HARQ acknowledgement from a total of 12 different UEs may be multiplexed within one PUCCH RB.

Next, the PUCCH format 1 is described. A scheduling request (SR) is transmitted in such a manner that a UE requests scheduling or does not request scheduling. An SR channel reuses an ACK/NACK channel structure in the PUCCH format 1a/1b, and configured according to an on-off keying (OOK) scheme based on the ACK/NACK channel design. A reference signal is not transmitted in the SR channel. Accordingly, a sequence of a length 7 is used in the case of a normal CP, and a sequence of a length 6 is used in the case of an extended CP. Different cyclic shifts or orthogonal coverings may be allocated to an SR and ACK/NACK. That is, for positive SR transmission, a UE transmits HARQ ACK/NACK through resources allocated for an SR. For negative SR transmission, a UE transmits HARQ ACK/NACK through resources allocated for ACK/NACK.

An enhanced-PUCCH (e-PUCCH) format is described below. The e-PUCCH may correspond to the PUCCH format 3 of an LTE-A system. A block spreading method may be applied to ACK/NACK transmission using the PUCCH format 3.

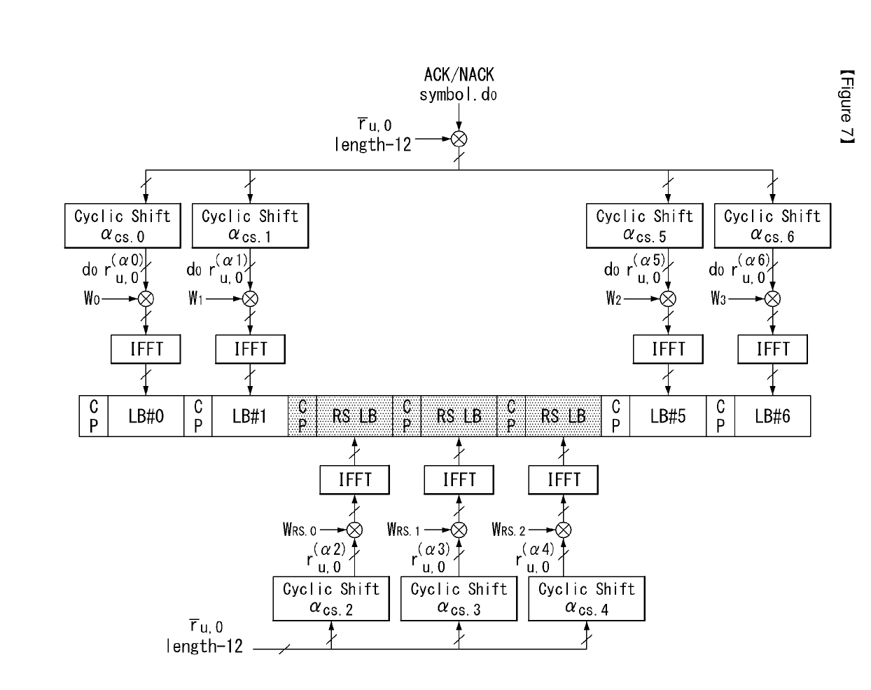

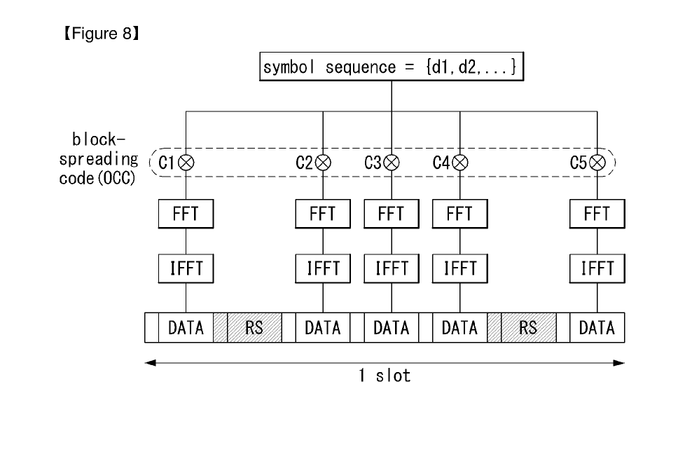

Unlike in the existing PUCCH format 1 series or 2 series, the block spreading method is a method of modulating control signal transmission using an SC-FDMA scheme. As shown in FIG. 8, a symbol sequence may be spread on the time domain using orthogonal cover code (OCC) and transmitted. The control signals of a plurality of UEs may be multiplexed on the same RB using the OCC. In the case of the PUCCH format 2, one symbol sequence is transmitted on the time domain, and the control signals of a plurality of UEs are multiplexed using the cyclic shift (CS) of a CAZAC sequence. In contrast, in the case of a block spreading-based PUCCH format (e.g., PUCCH format 3), one symbol sequence is transmitted on the frequency region, and the control signals of a plurality of UEs are multiplexed using time region spreading using the OCC.

FIG. 8 shows an example in which five SC-FDMA symbols are generated and transmitted during one slot in a wireless communication system to which the present invention may be applied.

FIG. 8 shows an example in which five SC-FDMA symbols (i.e., data parts) are generated and transmitted using OCC of a length=5 (or SF=5) in one symbol sequence during one slot. In this case, two RS symbols may be used during one slot.

In the example of FIG. 8, an RS symbol may be generated from a CAZAC sequence to which a specific cyclic shift value has been applied, and may be transmitted in a plurality of RS symbols in a form to which a specific OCC has been applied (or multiplied). Furthermore, in the example of FIG. 8, assuming that 12 modulation symbols are used for each OFDM symbol (or SC-FDMA symbol) and each modulation symbol is generated by QPSK, a maximum number of bits that may be transmitted in one slot are 12×2=24 bits. Accordingly, the number of bits that may be transmitted in 2 slots is a total of 48 bits. As described above, if the PUCCH channel structure of a block spreading method is used, control information of an extended size can be transmitted compared to the existing PUCCH format 1 series and 2 series.

General Carrier Aggregation

A communication environment considered in embodiments of the present invention includes multi-carrier supporting environments. That is, a multi-carrier system or a carrier aggregation system used in the present invention means a system that aggregates and uses one or more component carriers (CCs) having a smaller bandwidth smaller than a target band at the time of configuring a target wideband in order to support a wideband.

In the present invention, multi-carriers mean aggregation of (alternatively, carrier aggregation) of carriers and in this case, the aggregation of the carriers means both aggregation between continuous carriers and aggregation between non-contiguous carriers. Further, the number of component carriers aggregated between the downlink and the uplink may be differently set. A case in which the number of downlink component carriers (hereinafter, referred to as “DL CC”) and the number of uplink component carriers (hereinafter, referred to as “UL CC”) are the same as each other is referred to as symmetric aggregation and a case in which the number of downlink component carriers and the number of uplink component carriers are different from each other is referred to as asymmetric aggregation. The carrier aggregation may be interchangeably used with a term, such as a carrier aggregation, a bandwidth aggregation or a spectrum aggregation.

The carrier aggregation configured by combining two or more component carriers aims at supporting up to a bandwidth of 100 MHz in the LTE-A system. When one or more carriers having the bandwidth than the target band are combined, the bandwidth of the carriers to be combined may be limited to a bandwidth used in the existing system in order to maintain backward compatibility with the existing IMT system. For example, the existing 3GPP LTE system supports bandwidths of 1.4, 3, 5, 10, 15, and 20 MHz and a 3GPP LTE-advanced system (that is, LTE-A) may be configured to support a bandwidth larger than 20 MHz by using on the bandwidth for compatibility with the existing system. Further, the carrier aggregation system used in the preset invention may be configured to support the carrier aggregation by defining a new bandwidth regardless of the bandwidth used in the existing system.

The LTE-A system uses a concept of the cell in order to manage a radio resource.

The carrier aggregation environment may be called a multi-cell environment. The cell is defined as a combination of a pair of a downlink resource (DL CC) and an uplink resource (UL CC), but the uplink resource is not required. Therefore, the cell may be constituted by only the downlink resource or both the downlink resource and the uplink resource. When a specific terminal has only one configured serving cell, the cell may have one DL CC and one UL CC, but when the specific terminal has two or more configured serving cells, the cell has DL CCs as many as the cells and the number of UL CCs may be equal to or smaller than the number of DL CCs.

Alternatively, contrary to this, the DL CC and the UL CC may be configured. That is, when the specific terminal has multiple configured serving cells, a carrier aggregation environment having UL CCs more than DL CCs may also be supported. That is, the carrier aggregation may be appreciated as aggregation of two or more cells having different carrier frequencies (center frequencies). Herein, the described ‘cell’ needs to be distinguished from a cell as an area covered by the base station which is generally used.

The cell used in the LTE-A system includes a primary cell (PCell) and a secondary cell (SCell. The P cell and the S cell may be used as the serving cell. In a terminal which is in an RRC_CONNECTED state, but does not have the configured carrier aggregation or does not support the carrier aggregation, only one serving constituted by only the P cell is present. On the contrary, in a terminal which is in the RRC_CONNECTED state and has the configured carrier aggregation, one or more serving cells may be present and the P cell and one or more S cells are included in all serving cells.

The serving cell (P cell and S cell) may be configured through an RRC parameter. PhysCellId as a physical layer identifier of the cell has integer values of 0 to 503. SCellIndex as a short identifier used to identify the S cell has integer values of 1 to 7. ServCellIndex as a short identifier used to identify the serving cell (P cell or S cell) has the integer values of 0 to 7. The value of 0 is applied to the P cell and SCellIndex is previously granted for application to the S cell. That is, a cell having a smallest cell ID (alternatively, cell index) in ServCellIndex becomes the P cell.

The P cell means a cell that operates on a primary frequency (alternatively, primary CC). The terminal may be used to perform an initial connection establishment process or a connection re-establishment process and may be designated as a cell indicated during a handover process. Further, the P cell means a cell which becomes the center of control associated communication among serving cells configured in the carrier aggregation environment. That is, the terminal may be allocated with and transmit the PUCCH only in the P cell thereof and use only the P cell to acquire the system information or change a monitoring procedure. An evolved universal terrestrial radio access (E-UTRAN) may change only the P cell for the handover procedure to the terminal supporting the carrier aggregation environment by using an RRC connection reconfiguration message (RRCConnectionReconfiguration) message of an upper layer including mobile control information (mobilityControlInfo).

The S cell means a cell that operates on a secondary frequency (alternatively, secondary CC). Only one P cell may be allocated to a specific terminal and one or more S cells may be allocated to the specific terminal. The S cell may be configured after RRC connection establishment is achieved and used for providing an additional radio resource. The PUCCH is not present in residual cells other than the P cell, that is, the S cells among the serving cells configured in the carrier aggregation environment. The E-UTRAN may provide all system information associated with a related cell which is in an RRC_CONNECTED state through a dedicated signal at the time of adding the S cells to the terminal that supports the carrier aggregation environment. A change of the system information may be controlled by releasing and adding the related S cell and in this case, the RRC connection reconfiguration (RRCConnectionReconfiguration) message of the upper layer may be used. The E-UTRAN may perform having different parameters for each terminal rather than broadcasting in the related S cell.

After an initial security activation process starts, the E-UTRAN adds the S cells to the P cell initially configured during the connection establishment process to configure a network including one or more S cells. In the carrier aggregation environment, the P cell and the S cell may operate as the respective component carriers. In an embodiment described below, the primary component carrier (PCC) may be used as the same meaning as the P cell and the secondary component carrier (SCC) may be used as the same meaning as the S cell.

FIG. 9 illustrates examples of a component carrier and carrier aggregation in the wireless communication system to which the present invention can be applied.

FIG. 9a illustrates a single carrier structure used in an LTE system. The component carrier includes the DL CC and the UL CC. One component carrier may have a frequency range of 20 MHz.

FIG. 9b illustrates a carrier aggregation structure used in the LTE system. In the case of FIG. 9b, a case is illustrated, in which three component carriers having a frequency magnitude of 20 MHz are combined. Each of three DL CCs and three UL CCs is provided, but the number of DL CCs and the number of UL CCs are not limited. In the case of carrier aggregation, the terminal may simultaneously monitor three CCs, and receive downlink signal/data and transmit uplink signal/data.

When N DL CCs are managed in a specific cell, the network may allocate M (M≤N) DL CCs to the terminal. In this case, the terminal may monitor only M limited DL CCs and receive the DL signal. Further, the network gives L (L≤M≤N) DL CCs to allocate a primary DL CC to the terminal and in this case, UE needs to particularly monitor L DL CCs. Such a scheme may be similarly applied even to uplink transmission.

A linkage between a carrier frequency (alternatively, DL CC) of the downlink resource and a carrier frequency (alternatively, UL CC) of the uplink resource may be indicated by an upper-layer message such as the RRC message or the system information. For example, a combination of the DL resource and the UL resource may be configured by a linkage defined by system information block type 2 (SIB2). In detail, the linkage may mean a mapping relationship between the DL CC in which the PDCCH transporting a UL grant and a UL CC using the UL grant and mean a mapping relationship between the DL CC (alternatively, UL CC) in which data for the HARQ is transmitted and the UL CC (alternatively, DL CC) in which the HARQ ACK/NACK signal is transmitted.

Cross Carrier Scheduling

In the carrier aggregation system, in terms of scheduling for the carrier or the serving cell, two types of a self-scheduling method and a cross carrier scheduling method are provided. The cross carrier scheduling may be called cross component carrier scheduling or cross cell scheduling.

The cross carrier scheduling means transmitting the PDCCH (DL grant) and the PDSCH to different respective DL CCs or transmitting the PUSCH transmitted according to the PDCCH (UL grant) transmitted in the DL CC through other UL CC other than a UL CC linked with the DL CC receiving the UL grant.

Whether to perform the cross carrier scheduling may be UE-specifically activated or deactivated and semi-statically known for each terminal through the upper-layer signaling (for example, RRC signaling).

When the cross carrier scheduling is activated, a carrier indicator field (CIF) indicating through which DL/UL CC the PDSCH/PUSCH the PDSCH/PUSCH indicated by the corresponding PDCCH is transmitted is required. For example, the PDCCH may allocate the PDSCH resource or the PUSCH resource to one of multiple component carriers by using the CIF. That is, the CIF is set when the PDSCH or PUSCH resource is allocated to one of DL/UL CCs in which the PDCCH on the DL CC is multiply aggregated. In this case, a DCI format of LTE-A Release-8 may extend according to the CIF. In this case, the set CIF may be fixed to a 3-bit field and the position of the set CIF may be fixed regardless of the size of the DCI format. Further, a PDCCH structure (the same coding and the same CCE based resource mapping) of the LTE-A Release-8 may be reused.

In contrast, when the PDCCH on the DL CC allocates the PDSCH resource on the same DL CC or allocates the PUSCH resource on a UL CC which is singly linked, the CIF is not set. In this case, the same PDCCH structure (the same coding and the same CCE based resource mapping) and DCI format as the LTE-A Release-8 may be used.

When the cross carrier scheduling is possible, the terminal needs to monitor PDCCHs for a plurality of Das in a control region of a monitoring CC according to a transmission mode and/or a bandwidth for each CC. Therefore, a configuration and PDCCH monitoring of a search space which may support monitoring the PDCCHs for the plurality of Das are required.

In the carrier aggregation system, a terminal DL CC aggregate represents an aggregate of DL CCs in which the terminal is scheduled to receive the PDSCH and a terminal UL CC aggregate represents an aggregate of UL CCs in which the terminal is scheduled to transmit the PUSCH. Further, a PDCCH monitoring set represents a set of one or more DL CCs that perform the PDCCH monitoring. The PDCCH monitoring set may be the same as the terminal DL CC set or a subset of the terminal DL CC set. The PDCCH monitoring set may include at least any one of DL CCs in the terminal DL CC set. Alternatively, the PDCCH monitoring set may be defined separately regardless of the terminal DL CC set. The DL CCs included in the PDCCH monitoring set may be configured in such a manner that self-scheduling for the linked UL CC is continuously available. The terminal DL CC set, the terminal UL CC set, and the PDCCH monitoring set may be configured UE-specifically, UE group-specifically, or cell-specifically.

When the cross carrier scheduling is deactivated, the deactivation of the cross carrier scheduling means that the PDCCH monitoring set continuously means the terminal DL CC set and in this case, an indication such as separate signaling for the PDCCH monitoring set is not required. However, when the cross carrier scheduling is activated, the PDCCH monitoring set is preferably defined in the terminal DL CC set. That is, the base station transmits the PDCCH through only the PDCCH monitoring set in order to schedule the PDSCH or PUSCH for the terminal.

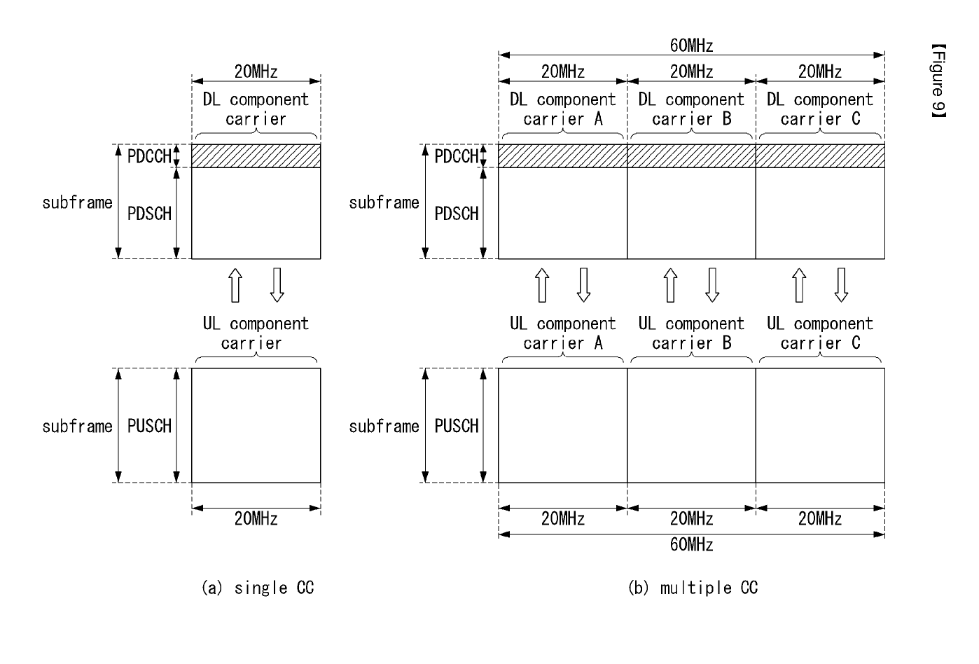

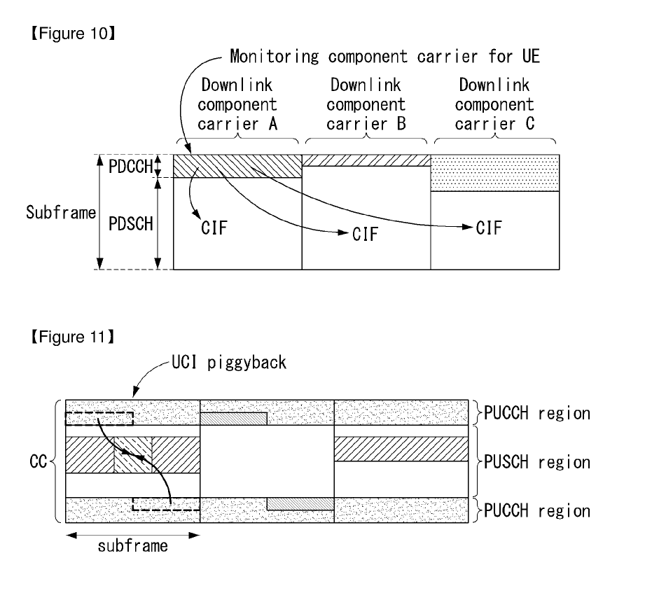

FIG. 10 illustrates one example of a subframe structure depending on cross carrier scheduling in the wireless communication system to which the present invention can be applied.

Referring to FIG. 10, a case is illustrated, in which three DL CCs are associated with a DL subframe for an LTE-A terminal and DL CC′A′ is configured as a PDCCH monitoring DL CC. When the CIF is not used, each DL CC may transmit the PDCCH scheduling the PDSCH thereof without the CIF. On the contrary, when the CIF is used through the upper-layer signaling, only one DL CC ‘A’ may transmit the PDCCH scheduling the PDSCH thereof or the PDSCH of another CC by using the CIF. In this case, DL CC ‘B’ and ‘C’ in which the PDCCH monitoring DL CC is not configured does not transmit the PDCCH.

Common ACK/NACK Multiplexing Method

In a situation in which a UE has to transmit a plurality of ACK/NACKs corresponding to a plurality of data units received from an eNB at the same time, in order to maintain the single-frequency characteristic of an ACK/NACK signal and to reduce ACK/NACK transmission power, an ACK/NACK multiplexing method based on the selection of PUCCH resources may be taken into consideration.

The content of ACK/NACK responses to the plurality of data units along with ACK/NACK multiplexing is identified by a combination of PUCCH resources used for actual ACK/NACK transmission and the resources of QPSK modulation symbols.

For example, if one PUCCH resources transmit 4 bits and a maximum of 4 data units may be transmitted, ACK/NACK results may be identified by an eNB as in Table 3.

TABLE 3

| HARQ-ACK(0), HARQ-ACK(1), HARQ- | | |
|---|---|---|
| ACK(2), HARQ-ACK(3) | n_{PUCCH}⁽¹⁾ | b(0), b(1) |
| ACK, ACK, ACK, ACK | n_{PUCCH, 1}⁽¹⁾ | 1, 1 |
| ACK, ACK, ACK, NACK/DTX | n_{PUCCH, 1}⁽¹⁾ | 1, 0 |
| NACK/DTX, NACK/DTX, NACK, DTX | n_{PUCCH, 2}⁽¹⁾ | 1, 1 |
| ACK, ACK, NACK/DTX, ACK | n_{PUCCH, 1}⁽¹⁾ | 1, 0 |
| NACK, DTX, DTX, DTX | n_{PUCCH, 0}⁽¹⁾ | 1, 0 |
| ACK, ACK, NACK/DTX, NACK/DTX | n_{PUCCH, 1}⁽¹⁾ | 1, 0 |
| ACK, NACK/DTX, ACK, ACK | n_{PUCCH, 3}⁽¹⁾ | 0, 1 |
| NACK/DTX, NACK/DTX, NACK/DTX, | n_{PUCCH, 3}⁽¹⁾ | 1, 1 |
| NACK | | |
| ACK, NACK/DTX, ACK, NACK/DTX | n_{PUCCH, 2}⁽¹⁾ | 0, 1 |
| ACK, NACK/DTX, NACK/DTX, ACK | n_{PUCCH, 0}⁽¹⁾ | 0, 1 |
| ACK, NACK/DTX, NACK/DTX, NACK/DTX | n_{PUCCH, 0}⁽¹⁾ | 1, 1 |
| NACK/DTX, ACK, ACK, ACK | n_{PUCCH, 3}⁽¹⁾ | 0, 1 |
| NACK/DTX, NACK, DTX, DTX | n_{PUCCH, 1}⁽¹⁾ | 0, 0 |
| NACK/DTX, ACK, ACK, NACK/DTX | n_{PUCCH, 2}⁽¹⁾ | 1, 0 |
| NACK/DTX, ACK, NACK/DTX, ACK | n_{PUCCH, 3}⁽¹⁾ | 1, 0 |
| NACK/DTX, ACK, NACK/DTX, NACK/DTX | n_{PUCCH, 1}⁽¹⁾ | 0, 1 |
| NACK/DTX, NACK/DTX, ACK, ACK | n_{PUCCH, 3}⁽¹⁾ | 0, 1 |
| NACK/DTX, NACK/DTX, ACK, NACK/DTX | n_{PUCCH, 2}⁽¹⁾ | 0, 0 |
| NACK/DTX, NACK/DTX, NACK/DTX, ACK | n_{PUCCH, 3}⁽¹⁾ | 0, 0 |
| DTX, DTX, DTX, DTX | N/A | N/A |

In Table 3, HARQ-ACK(i) indicates ACK/NACK results for an i-th data unit. In Table 3, discontinuous transmission (DTX) means that there is no data unit to be transmitted for corresponding HARQ-ACK(i) or that a UE has not detected a data unit corresponding to HARQ-ACK(i).

According to Table 3, a maximum of four PUCCH resources n_{PUCCH,0}⁽¹⁾, n_{PUCCH,1}⁽¹⁾, n_{PUCCH,2}⁽¹⁾, and n_{PUCCH,3}⁽¹⁾ are present, and b(0), b(1) is 2 bits transmitted using a selected PUCCH.

For example, when a UE successfully receives all of 4 data units, the UE transmits the 2 bits (1,1) using n_{PUCCH,1}⁽¹⁾.

If the UE fails in decoding the first and the third data units and are successful in decoding the second and the fourth data units, the UE transmits the bits (1,0) using n_{PUCCH,3}⁽¹⁾.

In ACK/NACK channel selection, if at least one ACK is present, NACK and DTX are coupled. The reason for this is that all of ACK/NACK states cannot be expressed using a combination of reserved PUCCH resources and an QPSK symbol. If ACK is not present, however, the DTX is decoupled from the NACK.

In this case, a PUCCH resource linked to a data unit corresponding to one clear NACK may be reserved to transmit a plurality of signals of ACK/NACKs.

PDCCH Validation for Semi-Persistent Scheduling

Semi-persistent scheduling (SPS) is a scheduling method for allocating resources to a specific UE so that the resources are persistently maintained for a specific time interval.

If a specific amount of data is transmitted during a specific time as in the voice over Internet protocol (VoIP), the consumption of control information can be reduce using the SPS scheme because it is not necessary to transmit the control information every data transmission interval for resource allocation. In the so-called semi-persistent scheduling (SPS) method, a time resource region to which resources may be allocated is first allocated to a UE.

In this case, in the semi-persistent scheduling method, a time resource region allocated to a specific UE may be configured to have periodicity. Thereafter, the allocation of time-frequency resources is completed by allocating a frequency resource region, if necessary. To allocate the frequency resource region as described is called so-called activation. If the semi-persistent scheduling method is used, signaling overhead can be reduced because resource allocation is maintained for a specific time by one signaling and thus it is not necessary to perform resource allocation periodically.

Thereafter, if resource allocation to the UE is not necessary, signaling for releasing the frequency resource allocation may be transmitted from an eNB to the UE. To release the allocation of the frequency resource region as described may be called deactivation.

In current LTE, for SPS for the uplink and/or the downlink, first, a UE is notified that the UE has to perform SPS transmission/reception in which subframes through radio resource control (RRC) signaling. That is, the time resource of time-frequency resources allocated for SPS is first designated through RRC signaling. In order to notify the UE of a subframe to be used, for example, the UE may be notified of the cycle and offset of a subframe, for example. However, since only the time resource region is allocated to the UE through RRC signaling, the UE does not directly perform transmission and reception according to SPS although it receives the RRC signaling, and completes the allocation of time-frequency resources by allocating a frequency resource region. To allocate the frequency resource region as described above may be called activation, and to release the allocation of the frequency resource region may be called deactivation.

Accordingly, after receiving a PDCCH indicative of activation, the UE allocates a frequency resource according to RB allocation information included in the received PDCCH and starts to perform transmission and reception based on the subframe cycle and offset allocated through the RRC signaling by applying a modulation and code rate according to modulation and coding scheme (MCS) information.

Next, when the UE receives a PDCCH indicative of deactivation from the eNB, it stops transmission and reception. When a PDCCH indicative of activation or reactivation is received after the transmission and reception are stopped, the UE resumes transmission and reception based on a subframe cycle and offset allocated through RRC signaling using RB allocation and an MCS designated in the PDCCH. That is, the allocation of the time resource is performed through RRC signaling, but the transmission and reception of an actual signal may be performed after a PDCCH indicative of the activation and reactivation of SPS is received. The stop of the signal transmission and reception is performed after a PDCCH indicative of the deactivation of the SPS is received.

If all the following conditions are satisfied, the UE may validate a PDCCH including SPS indication. First, CRC parity bits added for PDCCH payload need to be scrambled in to an SPS C-RNTI. Second, a data indicator (NDI) field needs to be set to 0. In this case, in the case of the DCI formats 2, 2A, 2B and 2C, a new data indicator field indicates one of activated transport blocks.

Furthermore, when each field used for the DCI format is set according to Table 4 and Table 5, the validation is completed. When such a validation is completed, the UE recognizes that received DCI information is valid SPS activation or deactivation (or release). In contrast, if the validation is not completed, the UE recognizes that non-matching CRC has been included in the received DCI format.

Table 4 shows fields for PDCCH validation indicative of SPS activation.

TABLE 4

| | DCI | DCI | DCI |
|---|---|---|---|
| | format 0 | format 1/1A | format 2/2A/2B |
| TPC command for | set | N/A | N/A |
| scheduled PUSCH | to “00” | | |
| Cyclic shift | set | N/A | N/A |
| DM RS | to “000” | | |
| Modulation and | MSB is set | N/A | N/A |
| coding scheme | to “0” | | |
| and redundancy | | | |
| version | | | |
| HARQ process | N/A | FDD: set | FDD: set |
| number | | to “000” | to “000” |
| | | TDD: set | TDD: set |
| | | to “0000” | to “0000” |
| Modulation and | N/A | MSB is set | For the enabled |
| coding scheme | | to “0” | transport block: |
| | | | MSB is set |
| | | | to “0” |
| Redundancy | N/A | set | For the enabled |
| version | | to “00” | transport block: |
| | | | set to “00” |

Table 5 shows fields for PDCCH validation indicative of SPS deactivation (or release).

TABLE 5

| | DCI format 0 | DCI format 1A |
|---|---|---|
| TPC command for scheduled | set to ‘00’ | N/A |
| PUSCH | | |
| Cyclic shift DM RS | set to ‘000’ | N/A |
| Modulation and coding scheme | set to ‘11111’ | N/A |
| and redundancy version | | |
| Resource block assignment and | Set to all “1”s | N/A |
| hopping resource allocation | | |
| HARQ process number | N/A | FDD: set to ‘000’ |
| | | TDD: set to ‘0000’ |
| Modulation and coding scheme | N/A | set to ‘11111’ |
| Redundancy version | N/A | set to ‘00’ |
| Resource block assignment | N/A | Set to all “1”s |

If the DCI format indicates SPS downlink scheduling activation, a TPC command value for a PUCCH field may be used an index indicative of 4 PUCCH resource values configured by a higher layer.

PUCCH Piggybacking in Rel-8 LTE

FIG. 11 shows an example of the transport channel processing of an UL-SCH in a wireless communication system to which the present invention may be applied.

In the 3GPP LTE system (=E-UTRA, Rel. 8), in the case of UL, for the efficient utilization of the power AMP of a UE, single carrier transmission having a good peak-to-average power ratio (PAPR) characteristic or cubic metric (CM) characteristic that affects performance of the power AMP has been made to be maintained. That is, in the case of PUSCH transmission of the existing LTE system, data to be transmitted maintains a single carrier characteristic through DFT-precoding. In the case of PUCCH transmission, information is carried on a sequence having the single carrier characteristic and transmitted in order to maintain the single carrier characteristic. However, in DFT-precoding, if one datum is non-contiguously allocated in the frequency axis or a PUSCH and a PUCCH are transmitted at the same time, such a single carrier characteristic is broken. Accordingly, as in FIG. 11, if PUSCH transmission is present in the same subframe as PUCCH transmission, in order to maintain the single carrier characteristic, uplink control information (UCI) information to be transmitted in the PUCCH has been piggybacked through the PUSCH.

As described above, the existing LTE UE uses a method of multiplexing uplink control information (UCI) (CQI/PMI, HARQ-ACK, and RI) with a PUSCH region in a subframe in which a PUSCH is transmitted because a PUCCH and a PUSCH cannot be transmitted at the same time.

For example, if a channel quality indicator (CQI) and/or a precoding matrix indicator (PMI) have to be transmitted in a subframe allocated to transmit a PUSCH, UL-SCH data and the CQI/PMI may be multiplexed prior to DFT-spreading and transmitted along with control information and data. In this case, rate-matching is performed on the UL-SCH data by taking into consideration CQI/PMI resources. Furthermore, a method of puncturing the UL-SCH data and multiplexing the control information, such as the HARQ ACK, and RI, with the PUSCH region is used.

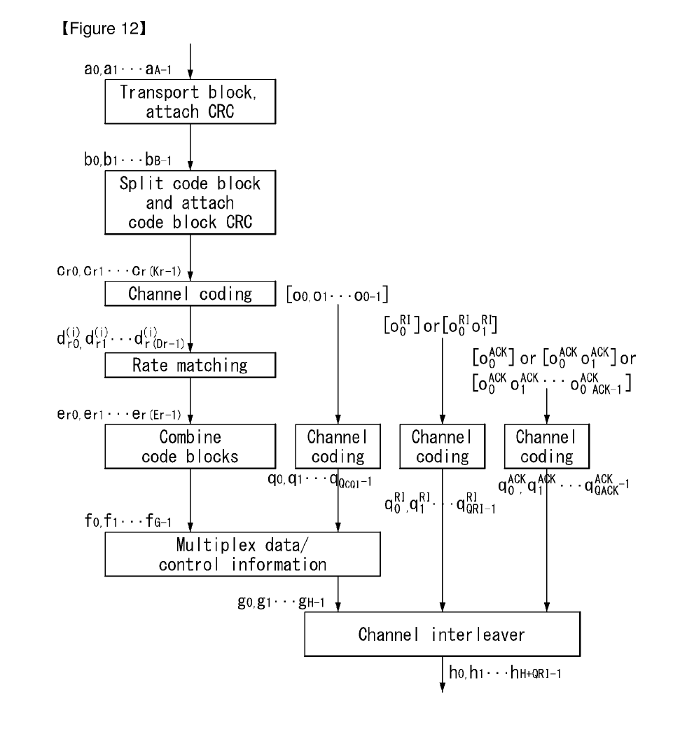

FIG. 12 shows an example of the signal processing process of an uplink shared channel, that is, a transport channel, in a wireless communication system to which the present invention may be applied.

Hereinafter, the signal processing process of an uplink shared channel (hereinafter called an “UL-SCH”) may be applied to one or more transport channels or control information types.

Referring to FIG. 12, an UL-SCH transfers data to a coding unit in the form of a transport block (TB) every transmission time interval (TTI).

CRC parity bits p₀, p₁, p₂, p₃, . . . , p_{L-1} are attached to the bits a₀, a₁, a₂, a₃, . . . , a_{A-1} of the transport block received from a higher layer (S120). In this case, A is the size of the transport block, and L is the number of parity bits. Input bits to which the CRC has been attached are b₀, b₁, b₂, b₃, . . . , b_{B-1}. In this case, B indicates the number of bits of the transport block including the CRC.

b₀, b₁, b₂, b₃, . . . , b_{B-1} is segmented into several code blocks (CB) depending on the TB size and CRC is attached to the segmented several CBs (S121). After the code block segmentation and the CRC attachment, bits are cᵣ₀, cᵣ₁, cᵣ₂, cᵣ₃, . . . , c_{r(K}_{ᵣ}₋₁₎. In this case, r is a code block number (r=0, . . . , C−1), and Kr is the number of bits according to the code block r. Furthermore, C indicates a total number of code blocks.

Next, channel coding is performed (S122). Output bits after the channel coding are dᵣ₀⁽ⁱ⁾, dᵣ₁⁽ⁱ⁾, dᵣ₂⁽ⁱ⁾, dᵣ₃⁽ⁱ⁾, . . . , d_{r(D}_{ᵣ}₋₁₎⁽ⁱ⁾. In this case, i is a coded stream index and may have a 0, 1 or 2 value. Dr indicates the number of bits of an i-th coded stream for the code block r. r is a code block number (r=0, . . . , C−1), and C indicates a total number of code blocks. Each code block may be coded by each turbo coding.

Next, rate matching is performed (S123). Bits after experiencing the rate matching are eᵣ₀, eᵣ₁, eᵣ₂, eᵣ₃, . . . , e_{r(E}_{ᵣ}₋₁₎. In this case, r indicates a code block number (r=0, . . . , C−1), and C indicates a total number of code blocks. Er indicates the number of rate-matched bits of the r-th code block.

Next, the concatenation between the code blocks is performed (S124). Bits after the concatenation of the code blocks is performed are f₀, f₁, f₂, f₃, . . . , f_{G-1}. In this case, G indicates a total number of coded bits for transmission. When control information is multiplexed with UL-SCH transmission, the number of bits used for control information transmission is not included.

Meanwhile, when control information is transmitted in a PUSCH, channel coding is performed on each of a CQI/PMI, an RI, and ACK/NACK, that is, control information (S126, S127, S128). For the transmission of each of the pieces of control information, each of the pieces of control information has a different coding rate because a different coded symbol is allocated to each of the pieces of control information.

In time division duplex (TDD), two modes of ACK/NACK bundling and ACK/NACK multiplexing are supported for an ACK/NACK feedback mode by a higher layer configuration. For the ACK/NACK bundling, an ACK/NACK information bit includes 1 bit or 2 bits. For the ACK/NACK multiplexing, an ACK/NACK information bit has 1 bit to 4 bits.

After the code blocks are concatenated at step S134, the multiplexing of the coded bits f₀, f₁, f₂, f₃, . . . , f_{G-1} of the UL-SCH data and the coded bits q₀, q₁, q₂, q₃, . . . , q_{N}_{_{L}}_{·Q}_{_{CQI}}₋₁ of the CQI/PMI is performed (S125). The multiplexed results of the data and the CQI/PMI are g₀, g₁, g₂, g₃, . . . , g_{H′-1}. In this case, g, (i=0, . . . , H′−1) indicates a column vector having a (Qₘ·N_{L}) length. H=(G+N_{L}·Q_{CQI}) and H′=H/(N_{L}·Qₘ). N_{L} indicates the number of layers to which an UL-SCH transmission block has been mapped, and H indicates a total number of coded bits allocated to N_{L} transport layers to which a transport block has been mapped for the UL-SCH data and the CQI/PMI information.

Next, the multiplexed data, the CQI/PMI, and the channel coded RI and ACK/NACK are subjected to channel interleaving to generate an output signal (S129).

Reference Signal (RS)

In a wireless communication system, a signal may be distorted during transmission because data is transmitted through a radio channel. In order for a reception stage to accurately receive the distorted signal, the distortion of the received signal must be corrected using channel information. In order to detect the channel information, a signal transmission method known to both the transmission side and the reception side and a method of detecting the channel information using the degree that the signal has been distorted when the signal is transmitted through the channel are chiefly used. The aforementioned signal is called a pilot signal or a reference signal (RS).

When data is transmitted and received using multiple input/output antennas, a channel state between a transmission antenna and a reception antenna must be detected in order to accurately receive the signal. Accordingly, each transmission antenna must have each reference signal.

A downlink reference signal includes a common reference signal (CRS) shared by all of UEs within one cell and a dedicated reference signal (DRS) for only a specific UE. Information for demodulation and channel measurement may be provided using reference signals.

A reception side (i.e., UE) measures a channel state from a CRS and feeds an indicator related to channel quality, such as a channel quality indicator (Cal), a precoding matrix index (PMI) and/or a rank indicator (RI), back to a transmission side (i.e., eNB). The CRS is also called a cell-specific reference signal (cell-specific RS). In contrast, a reference signal related to the feedback of channel state information (CSI) may be defined as a CSI-RS.

A DRS may be transmitted through resource elements if data demodulation on a PDSCH is necessary. The UE may receive whether a DRS is present or not through a higher layer, and the DRS is valid only when it is mapped to a corresponding PDSCH. The DRS may be called a UE-specific reference signal (UE-specific RS) or a demodulation RS (DMRS).

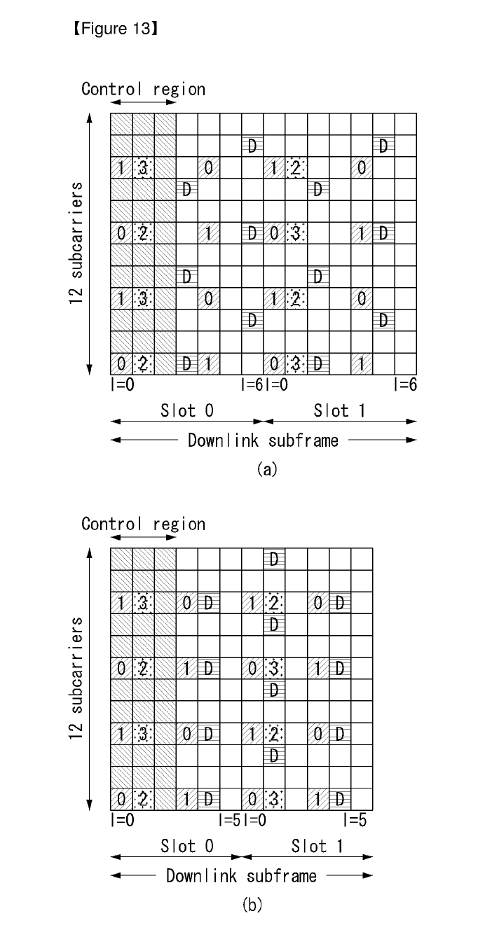

FIG. 13 illustrates a reference signal pattern mapped to a downlink resource block pair in a wireless communication system to which the present invention may be applied.

Referring to FIG. 13, as a unit in which a reference signal is mapped, a downlink resource block pair may be indicated as one subframe in the time domain×12 subcarriers in the frequency domain. That is, one resource block pair on the time axis (x axis) has a length of 14 OFDM symbols in the case of a normal cyclic prefix (normal CP) (FIG. 13a), and has a length of 12 OFDM symbol in the case of an extended cyclic prefix (extended CP) (FIG. 13b). In the resource block lattice, resource elements (REs) written in “0”, “1”, “2” and “3” mean the positions of the CRSs of respective antenna port indices “0”, “1”, “2” and “3”, and a resource element written in “D” means the position of a DRS.

A CRS is described more specifically below. The CRS is used to estimate the channel of a physical antenna and is a reference signal that may be received by all of UEs located within a cell in common and is distributed to a full frequency band. Furthermore, the CRS may be used for channel quality information (CSI) and data demodulation.

A CRS is defined in various formats depending on an antenna array in a transmission side (eNB). In the 3GPP LTE system (e.g., Release-8), various antenna arrays are supported, and a downlink signal transmission side has three types of antenna arrays, such as 3-single transmission antennas, 2 transmission antennas and 4 transmission antennas. If the eNB uses a single transmission antenna, a reference signal for a single antenna port is arrayed. If the eNB uses the 2 transmission antennas, reference signals for 2 transmission antenna ports are arrayed using a time division multiplexing (TDM) scheme and/or a frequency segmented multiplexing (FDM) scheme. That is, in order to distinguish between the reference signals for the 2 antenna ports, different time resources and/or different frequency resources are allocated.

Moreover, if the eNB uses the 4 transmission antennas, reference signals for 4 transmission antenna ports are arrayed using the TDM and/or FDM scheme. Channel information measured by the reception side (UE) of a downlink signal may be used to demodulate data transmitted using a transmission scheme, such as single transmission antenna transmission, transmit diversity, closed-loop spatial multiplexing, open-loop spatial multiplexing or multi-user-multiple input/output antennas (multi-user MIMO).

If multiple input/output antennas are supported, when a reference signal is transmitted by a specific antenna port, the reference signal is transmitted at the position of specific resource elements depending on the pattern of the reference signal, and is not transmitted at the position of specific resource elements for other antenna ports. That is, a reference signal between different antennas does not overlap.

A rule that a CRS is mapped to a resource block is defined as follows.

$$k = 6 m + ( v + {v}_{shift} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL} \\ v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3 \end{matrix} \\ {v}_{shift} = {N}_{ID}^{cell} mod 6 \qquad [ Equation 1 ]$$

In Equation 1, k and l indicates each subcarrier index and symbol index, and p indicates an antenna port. N_{symb}^{DL} indicates the number of OFDM symbols in one downlink slot, and N_{RB}^{DL} indicates the number of radio resources allocated to the downlink. Ns indicates a slot index, and N_{ID}^{cell} indicates a cell ID. mod indicates modulo operation. The position of a reference signal is different depending on a v_{shift} value in the frequency domain. Since v_{shift} depends on a cell ID, the position of the reference signal has various frequency shift values depending on a cell.

More specifically, in order to improve channel estimation performance through a CRS, the position of the CRS may be shifted in the frequency domain depending on a cell. For example, if a reference signal is located at intervals of 3 subcarriers, reference signals in one cell are allocated to a 3k-th subcarrier, and a reference signal in another cell is allocated to a (3k+1)-th subcarrier. From a viewpoint of one antenna port, reference signals are arrayed at intervals of 6 resource elements in the frequency domain, and are decoupled from a reference signal allocated to another antenna port at intervals of 3 resource elements.

In the time domain, a reference signal starts from the symbol index 0 of each slot and is arranged at a constant interval. The time interval is differently defined depending on a cyclic shift length. In the case of a normal cyclic prefix, a reference signal is located at the symbol indices 0 and 4 of a slot. In the case of an extended cyclic prefix, a reference signal is located at the symbol indices 0 and 3 of a slot. A reference signal for an antenna port that belongs to two antenna ports and that has a maximum value is defined within one OFDM symbol. Accordingly, in the case of 4-transmission antenna transmission, reference signals for reference signal antenna ports 0 and 1 are located at the symbol indices 0 and 4 (symbol indices 0 and 3 in the case of an extended cyclic prefix) of a slot. Reference signals for antenna ports 2 and 3 are located at the symbol index 1 of a slot. The position of a reference signal for the antenna ports 2 and 3 in the frequency region is exchanged in the second slot.

A DRS is described more specifically below. A DRS is used to demodulate data. In multiple input/output antennas transmission, a precoding weight used for a specific UE is combined with a transport channel transmitted in each transmission antenna when a UE receives a reference signal, and is used without any change in order to estimate a corresponding channel.

The 3GPP LTE system (e.g., Release-8) supports a maximum of 4 transmission antennas, and a DRS for rank 1 beamforming is defined. The DRS for rank 1 beamforming also indicates a reference signal for an antenna port index 5.

A rule that a DRS is mapped to a resource block is defined as follows. Equation 2 shows the case of a normal cyclic prefix, and Equation 3 shows the case of an extended cyclic prefix.

$$\begin{matrix}k = ( {k}^{′} ) mod {N}_{sc}^{RB} + {N}_{sc}^{RB} \cdot {n}_{PRB} \\ {k}^{′} = \{ \begin{matrix}4 {m}^{′} + {v}_{shift} & if l ∈ \{ 2 , 3 \} \\ 4 {m}^{′} + ( 2 + {v}_{shift} ) mod 4 & if l ∈ \{ 5 , 6 \}\end{matrix} \\ l = \{ \begin{matrix}3 & {l}^{′} = 0 \\ 6 & {l}^{′} = 1 \\ 2 & {l}^{′} = 2 \\ 5 & {l}^{′} = 3\end{matrix} \\ {l}^{′} = \{ \begin{matrix}0 , 1 & if {n}_{s} mod 2 = 0 \\ 2 , 3 & if {n}_{s} mod 2 = 1\end{matrix} \\ {m}^{′} = 0 , 1 , … , 3 {N}_{RB}^{PDSCH} - 1 \\ {v}_{shift} = {N}_{ID}^{cell} mod 3 & [ Equation 2 ] \\ k = ( {k}^{′} ) mod {N}_{sc}^{RB} + {N}_{sc}^{RB} \cdot {n}_{PRB} \\ {k}^{′} = \{ \begin{matrix}3 {m}^{′} + {v}_{shift} & if l = 4 \\ 3 {m}^{′} + ( 2 + {v}_{shift} ) mod 3 & if l = 1\end{matrix} \\ l = \{ \begin{matrix}4 & {l}^{′} ∈ \{ 0 , 2 \} \\ 1 & {l}^{′} = 1\end{matrix} \\ {l}^{′} = \{ \begin{matrix}0 & if {n}_{s} mod 2 = 0 \\ 1 , 2 & if {n}_{s} mod 2 = 1\end{matrix} \\ {m}^{′} = 0 , 1 , … , 4 {N}_{RB}^{PDSCH} - 1 \\ {v}_{shift} = {N}_{ID}^{cell} mod 3 & [ Equation 3 ]\end{matrix}$$

In Equation 1 to Equation 3, k and p indicates a subcarrier index and an antenna port, respectively. N_{RB}^{DL}, ns, and N_{ID}^{cell} indicate the number of RBs allocated to the downlink, the number of slot indices, and the number of cell IDs. The position of an RS is different depending on a v_{shift} value from a viewpoint of the frequency domain.

In Equations 2 and 3, k and l indicates a subcarrier index and a symbol index, respectively, and p indicates an antenna port. N_{sc}^{RB} indicates a resource block size in the frequency domain and is expressed as the number of subcarriers. n_{PRB} indicates the number of physical resource blocks. N_{RB}^{PDSCH} indicates the frequency band of a resource block for PDSCH transmission. ns indicates a slot index, and N_{ID}^{cell} indicates a cell ID. mod indicates modulo operation. The position of a reference signal is different depending on the v_{shift} value in the frequency domain. Since v_{shift} depends on a cell ID, the position of a reference signal has various frequency shifts depending on a cell.

Sounding Reference Signal (SRS)

An SRS is chiefly used for channel quality measurement in order to perform frequency-selective scheduling in the uplink, and is not related to the transmission of uplink data and/or control information. However, the present invention is not limited thereto, and the SRS may be used for improving power control or various other objects for supporting various start-up functions of a UE that have not recently been scheduled. For example, the start-up function may include an initial modulation and coding scheme (MCS), initial power control for data transmission, timing advance and frequency semi-selective scheduling. In this case, frequency semi-selective scheduling means scheduling for selectively allocating a frequency resource to the first slot of a subframe and allocating a frequency resource in such a way as to pseudo-randomly jump to another frequency in the second slot of the subframe.

Furthermore, an SRS may be used to measure downlink channel quality, assuming that a radio channel is reciprocal between the uplink and the downlink. Such an assumption is particularly valid in a time division duplex (TDD) system in which the uplink and the downlink share the same frequency spectrum and are separated in the time domain.

The subframes of an SRS transmitted by any UE within a cell may be indicated by a cell-specific broadcasting signal. A 4-bit cell-specific “srsSubframeConfiguration” parameter indicates an array of 15 possible subframes in which an SRS may be transmitted through each radio frame. In accordance with such arrays, flexibility for the adjustment of SRS overhead is provided according to a deployment scenario.

In the 16-th array of the arrays, the switch of an SRS is fully off within a cell, which is suitable for a serving cell that chiefly serves high-speed UEs.

FIG. 14 illustrates an uplink subframe including a sounding reference signal symbol in a wireless communication system to which the present invention may be applied.

Referring to FIG. 14, an SRS is always transmitted through the last SC-FDMA symbol on an arrayed subframe. Accordingly, an SRS and a DMRS are located in different SC-FDMA symbols.

PUSCH data transmission is not permitted in a specific SC-FDMA symbol for SRS transmission. As a result, if sounding overhead is the greatest, that is, although an SRS symbol is included in all of subframes, sounding overhead does not exceed about 7%.

Each SRS symbol is generated by a base sequence (random sequence or sequence set based on Zadoff-Ch (ZC)) regarding a given time unit and a frequency band. All of UEs within the same cell use the same base sequence. In this case, SRS transmission from a plurality of UEs within the same cell in the same frequency band and the same time become orthogonal and distinguished by the different cyclic shifts of a base sequence.

Since a different base sequence is allocated to each cell, SRS sequences from different cells may be distinguished, but orthogonality between different base sequences is not guaranteed.

Coordinated Multi-Point (COMP) Transmission and Reception

In line with the needs of LTE-advanced, CoMP transmission was proposed for performance improvement of a system. A CoMP is also called co-MIMO, collaborative MIMO or network MIMO. A CoMP is expected to improve performance of a UE located in a cell boundary and to improve the throughput of an average cell (sector).

In general, inter-cell interference deteriorates performance of a UE located in a cell boundary and average cell (sector) throughput a multi-cell environment in which a frequency reuse index is 1. In order to reduce inter-cell interference, a simple passive method, such as fractional frequency reuse (FFR), has been applied in the LTE system so that a UE located in a cell boundary has proper performance throughput in an interference-limited environment. However, a method of reusing inter-cell interference or reducing inter-cell interference as the desired signal of a UE instead of reducing the use of frequency resources per cell becomes a better gain. In order to achieve the aforementioned object, a CoMP transmission scheme may be applied.

CoMP schemes that may be applied to the downlink may be classified into a joint processing (JP) scheme and a coordinated scheduling/beamforming (CS/CB) scheme.

In the JP scheme, data may be used in each point (eNB) of a CoMP unit. The CoMP unit means a set of eNBs used in the CoMP scheme. The JP scheme may be divided into a joint transmission scheme and a dynamic cell selection scheme.

The joint transmission scheme means a scheme in which signals are transmitted by some or all of a plurality of points at the same time through a PDSCH in a CoMP unit. That is, data transmitted to a single UE may be transmitted by a plurality of transmission points at the same time. Quality of a signal transmitted to a UE can be improved regardless of whether it is coherently or non-coherent, and interference with another UE can be actively removed through the joint transmission scheme.

The dynamic cell selection scheme means a scheme in which a signal is transmitted by a single point in a CoMP unit through a PDSCH. That is, data transmitted to a single UE on a specific time is transmitted by a single point, and another point within the CoMP unit does not transmit data to the UE. A point that transmits data to a UE may be dynamically selected.

In accordance with the CS/CB scheme, a CoMP unit performs beamforming through cooperation for data transmission to a single UE. That is, data is transmitted to the UE only in a serving cell, but user scheduling/beamforming may be determined through cooperation between a plurality of cells within the CoMP unit.

In the case of the uplink, CoMP reception means the reception of a signal transmitted by cooperation between a plurality of points that are geographically separated. A CoMP scheme that may be applied to the uplink may be divided into a joint reception (JR) scheme and a coordinated scheduling/beamforming (CS/CB) scheme.

The JR scheme means a scheme in which a CoMP unit receives a signal transmitted by some or all of a plurality of points through a PDSCH. In the CS/CB scheme, a signal transmitted through a PDSCH is received only in a single point, but in the user scheduling/beamforming, a signal may be determined through cooperation between a plurality of cells within a CoMP unit.

Cross-CC Scheduling and E-PDCCH Scheduling

In the existing 3GPP LTE Rel-10 system, if a cross-CC scheduling operation in an aggregation situation of a plurality of component carriers (CC=(serving) cells) is defined, one CC (i.e. scheduled CC) may be previously configured to receive DL/UL scheduling (i.e., a DL/UL grant PDCCH for a corresponding scheduled CC can be received) from only a specific one CC (i.e. scheduling CC).

The corresponding scheduling CC may basically perform DL/UL scheduling on its own scheduling CC.

In other words, all of the SSs of a PDCCH that schedule scheduling/scheduled CCs having a cross-CC scheduling relation may be present in the control channel region of a scheduling CC.

Meanwhile, in the LTE system, in an FDD DL carrier or TDD DL subframes, the first n OFDM symbols of the subframe are used for the transmission of a PDCCH, PHICH or PCFICH, that is, a physical channel for various types of control information transmission, and the remaining OFDM symbols are used for PDSCH transmission.

In this case, the number of symbols used for control channel transmission in each subframe is transmitted to a UE dynamically through a physical channel, such as a PCFICH, or in a semi-static manner through RRC signaling.

In this case, characteristically, an n value may be set up to a maximum of 4 symbols in 1 symbol depending on subframe characteristics and system characteristics (FDD/TDD, a system bandwidth, etc.).

Meanwhile, in the existing LTE system, a PDCCH, that is, a physical channel for transmitting DL/UL scheduling and various types of control information, has a limit because it is transmitted through limited OFDM symbols.

Accordingly, an enhanced PDCCH (i.e. E-PDCCH) in which a PDCCH and a PDSCH are multiplexed more freely according to the FDM/TDM scheme instead of a control channel transmitted through an OFDM symbol separated from the PDSCH may be introduced.

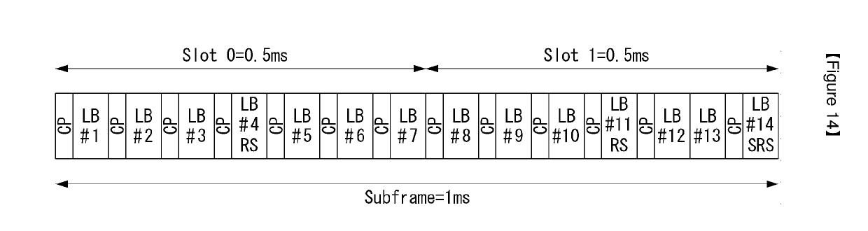

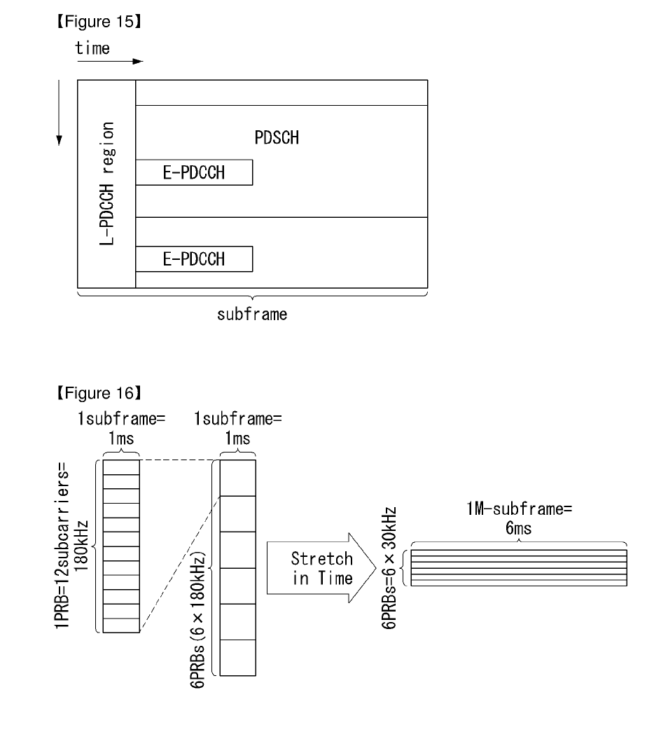

FIG. 15 is a diagram showing an example in which a legacy PDCCH, a PDSCH and an E-PDCCH are multiplexed.

In this case, the legacy PDCCH may be expressed as an L-PDCCH.

General Narrow Band (NB)-LTE System

Hereinafter, an NB-LTE (or NB-IoT) system is described.

The uplink of NB-LTE is based on SC-FDMA. This is a special case of SC-FDMA, and can make flexible the bandwidth allocation of a UE including single tone transmission.

One important aspect of uplink SC-FDMA is to synchronize times for a plurality of co-scheduled UEs so that an arrival time difference in an eNB is located within a cyclic prefix (CP).

Ideally, uplink 15 kHz subcarrier spacing must be used in NB-LTE, but time-accuracy that may be achieved when detecting a PRACH from UEs in a poor coverage condition must be taken into consideration.

Accordingly, CP duration needs to be increased.

One method for achieving this object is to reduce subcarrier spacing for an NB-LTE M-PUSCH to 2.5 kHz by dividing the 15 kHz subcarrier spacing by 6.

Another motivation for reducing the subcarrier spacing is to permit a high level of user multiplexing.

For example, one user is basically allocated to one subcarrier.

This is more effective for UEs having a very limited coverage condition, such as UEs whose system capacity is increased because a plurality of UEs uses maximum TX power at the same time, but which do not have a gain that a bandwidth is allocated.

SC-FDMA is used for the transmission of a plurality of tones in order to support a higher data rate along with an additional PAPR reduction technology.

Uplink NB-LTE includes three basic channels, including an M-PRACH, an M-PUCCH and an M-PUSCH.

Regarding the design of the M-PUCCH, at least three alternatives are being discussed as below.
One tone at each edge of a system bandwidth
UL control information transmission on the M-PRACH or M-PUSCH
Not having a dedicated UL control channel

Time-Domain Frame and Structure

In the uplink of NB-LTE having the 2.5 kHz subcarrier spacing, a radio frame and subframe are defined as 60 ms and 6 ms, respectively.

As in the downlink of NB-LTE, an M-frame and an M-subframe are identically defined in the uplink of NB-LTE.

FIG. 16 is a diagram showing that how the uplink numerology has been stretched in a time domain.

An NB-LTE carrier includes 6 PRBs in the frequency domain, and each NB-LTE PRB includes 12 subcarriers.

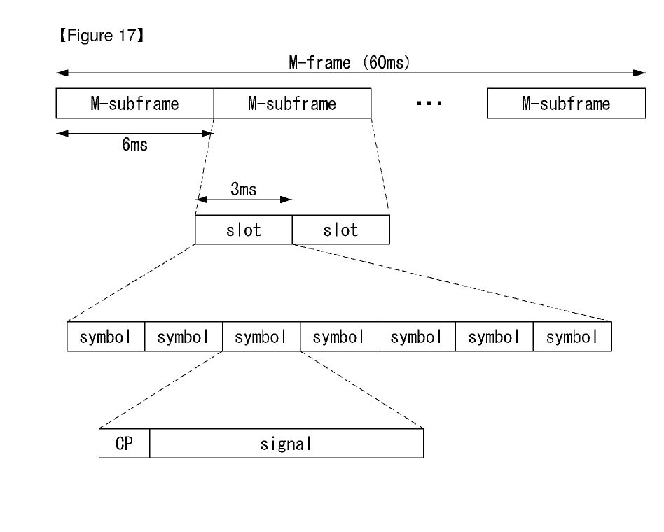

An uplink frame structure based on 2.5 kHz subcarrier spacing is shown in FIG. 17.

FIG. 16 shows an example of the uplink numerology stretched in the time domain when subcarrier spacing is reduced from 15 kHz to 2.5 kHz.

FIG. 17 is a diagram showing an example of time units for the uplink of NB-LTE based on 2.5 kHz subcarrier spacing.

NB-LTE System Operating Mode

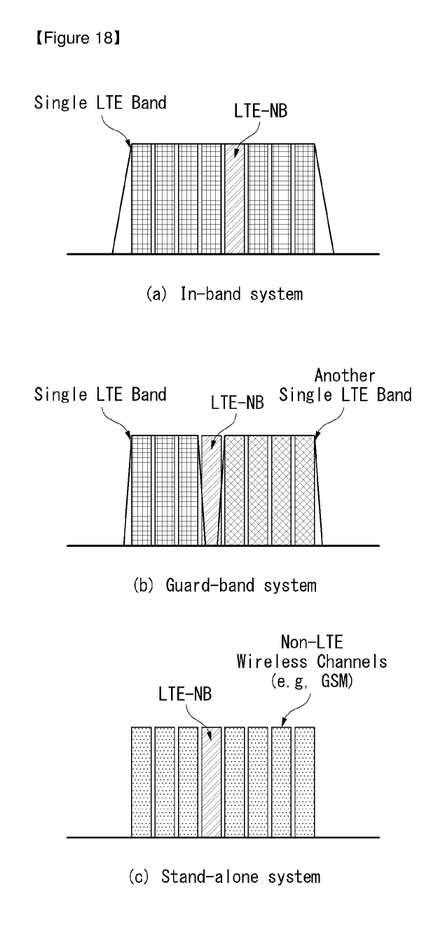

FIG. 18 is a diagram showing an example of the operating system of an NB LTE system to which a method proposed by this specification may be applied.

Specifically, FIG. 18a shows an in-band system, FIG. 18b shows a guard-band system, and FIG. 18c shows a stand-alone system.

The in-band system may be expressed as an in-band mode, the guard-band system may be expressed as a guard-band mode, and the stand-alone system may be expressed as a stand-alone mode.

The in-band system of FIG. 18a refers to a system or mode in which a specific 1 RB within a legacy LTE band is used for NB-LTE (or LTE-NB) and may be operated by allocating some resource blocks of an LTE system carrier.

The guard-band system of FIG. 18b refers to a system or mode in which NB-LTE is used for the space reserved for the guard band of a legacy LTE band, and may be operated by allocating the guard-band of ah LTE carrier not used as an RB in the LTE system.

The legacy LTE band has a guard band of at least 100 KHz at the last of each LTE band.

In order to use 200 KHz, two non-contiguous guard bands may be used.

The in-band system and the guard-band system show structures in which NB-LTE coexists within the legacy LTE band.

In contrast, the stand-alone system of FIG. 18c refers to a system or mode independently configured from a legacy LTE band and may be operated by separately allocating a frequency band (GSM carrier reallocated in the future) used in the GERAN.

In a next-generation communication system after LTE(-A) system, a scenario in which cheap and low-specification UEs are configured at a very high density and information obtained from sensors is transmitted and received through data communication is taken into consideration.

Such a UE of cheap and low specifications is hereinafter collectively called a “machine type communication (MTC) UE.”

If MTC UEs are distributed at high density, a transmission collision between the MTC UEs may frequently occur due to relatively insufficient resources.

Accordingly, it may be very difficult for an MTC UE to properly occupy a channel at desired timing and to successfully transmit data.

Furthermore, since the state of such an MTC UE may be very various, there is a need for a method of efficiently allocating resources to corresponding UEs in a high-density UE environment.

Accordingly, this specification proposes a resource allocation method and system operating method for efficient resource allocation in a high-density UE environment.

One of the characteristics of a cheap and low-specification UE, that is, an MTC UE, is sporadic transmission.

Sporadic transmission may mean a transmission method for an MTC UE to sporadically transmit uplink data and to then immediately switch to a sleep state so as to reduce battery consumption.

Accordingly, the MTC UE can reduce its power that much as overhead for transmitting one message is reduced.

Furthermore, such an MTC UE may be suitable for an application that belongs to Internet of things (IoT) applications and that transmits data sporadically or cyclically.

As an example of such an application, an application for cyclically transmitting a message, such as smart metering, may be taken into consideration.

In the case of the current LTE system, in order for an MTC UE to perform transmission having a cycle of a long time, the MTC UE wakes up from the sleep state and transmits uplink data the following (1) to (4) processes.

(1) Wake up from sleep, boot-up

(2) A synchronization procedure (for downlink reception)

A UE performs time/frequency synchronization based on the synchronization signal of a network.

(3) If downlink data, such as paging, is present, the UE performs reception, and transmits a scheduling request (SR) to the network (or eNB) if the transmission of uplink data is present.

A case where uplink transmission is triggered by paging depending on an application may be assumed.

1) An SR may be transmitted through an RACH procedure if a connection has not been established.

An RACH procedure may be performed according to the procedures of i) PRACH transmission, ii) random access response (RAR) reception, iii) message 3 (Msg 3) transmission for a contention resolution, and iv) message 4 (Msg 4) reception.

2) Thereafter (after the RACH procedure), a UE performs a buffer status report (BSR) report and waits for an UL grant from an eNB.

(4) After receiving the UL grant from the eNB, the UE transmits UL data.

As described above, the UL data transmission procedure of a UE is accompanied by a lot of overhead and delay.

Accordingly, methods for reducing the UL data transmission procedure need to be taken into consideration.

This specification provides a method in which a UE previously configures resources so that it can immediately perform uplink transmission even without transmitting a BSR and several UEs can share one resource.

That is, the (3) procedure can be omitted and the (4) process can be performed immediately after the (1) and (2) processes through the method proposed by this specification.

More characteristically, the attributes, application, and QoS class of data that may be transmitted may be limited or restricted through the method proposed by this specification.

That is, this means that data not satisfying specific criteria (the attributes, application, and QoS class of the data) is transmitted through a common process (this means that data is transmitted through (1) to (4)) although a UE uses a contention-based PUSCH.

Alternatively, the method proposed by this specification may be limitedly used for a specific application and data type that are greatly influenced by overhead.

This has an object of reducing overhead occurring as a UE communicates with a network through an RACH procedure although it has scheduling overhead.

The method (e.g., contention-based PUSCH transmission method) proposed by this specification has an object of enabling a UE to perform uplink transmission without an RRC connection, and thus a network (or eNB) needs to support some things for the UE.

First, in general, in the case of a UE having low mobility, a cell on which the UE has camped in the idle state may not be easily changed.

Accordingly, a network has to store information about a corresponding UE although the UE having low mobility switches to the idle state.

As an example, a C-RNTI allocated from a network to a UE may be taken into consideration.

If the network releases the C-RNTI allocated to the UE, many parts of the contention-based PUSCH transmission method, such as reference signal (RS) scrambling, need to be newly configured.

Accordingly, this specification proposes that a network does not release the C-RNTIs of UEs which will use a contention-based PUSCH.

Accordingly, if a cell on which a UE (having low mobility) has camped in the idle state is not changed, the UE may continue to use a previously allocated C-RNTI.

In this case, the C-RNTI may be defined to be released by a network if there is no UL data transmission from the UE through a contention-based PUSCH or there is no PRACH transmission from the UE for a specific time.

Alternatively, a definition may be made so that if the camp-on cell is changed, the UE transmits indication to the network and the C-RNTI is rapidly released.

In this case, the network may release reserved resources (for contention-based PUSCH transmission).

Furthermore, a definition may be made so that if the contention-based PUSCH resource is changed, the network notifies the UE of the change through an SIB so that the changed contents are updated.

(1) a method for a network (or eNB) to allocate a resource for UL data transmission to a UE and (2) a method for a UE to select a resource are described based on the aforementioned contents in relation to the uplink data transmission of a UE in a system in which UEs are distributed at high density, and (3) a resource allocation method for a UE that has not been synchronized is additionally described.

Resource Allocation Method in High-Density UE Environment

First, a method for a network or an eNB to allocate resources to a UE in a system in which UEs are distributed at high density is described.

In a system in which UEs are distributed at very high density, the state of the UEs is very various and the number of UEs is many, and thus a method for an eNB to dynamically allocate resources using the entire authority is very inefficient.

In order to solve such an inefficient problem, the following two methods (Method 1 and Method 2) may be taken into consideration.

Method 1 is a method of pre-granting resources.

That is, Method 1 is a method of allocating a dedicated resource per UE. A resource through which the uplink can be transmitted is previously granted to each UE so that a UE may transmit UL data using a corresponding resource.

If this method is applied to a UE in the idle state or many UEs, resource waste may become severe because many resources must be previously granted so that they do not overlap between UEs.

Furthermore, an UE in the idle state may have a difficulty in effectively using a resource because a network does not receive feedback from the corresponding UE.

Method 2 is a resource pool allocation method with contention-based transmission.

That is, Method 2 corresponds to a method for an eNB to suggest a specific criterion and UEs to use resources through contention within the corresponding criterion.

The resource allocation method described hereinafter is described based on Method 2, but contents proposed by this specification may also be applied to Method 1.

In the case of a high-density UE environment, an eNB first classifies a UE(s) into several groups according to a specific criterion because the number of UEs is too many.

For example, the eNB may notify a UE of the number of groups classified according to a specific criterion defined in a system through physical layer signaling or higher layer signaling. The UE may randomly select one of the received groups.

In addition, the UE may select any one group using its own identity (ID) or coverage class.

Furthermore, the group selected by the UE may be selected according to the expectation cycle of uplink transmission of the UE.

A plurality of available resource pools may be configured for each UE group, but a use fee for each resource pool may be differently set.

For example, a specific resource pool has a good collision probability, but may have a low data fee.

Accordingly, such a resource may be allocated to UEs whose reliability is not so important.

Alternatively, each resource pool may have a group, such as initial transmission, first retransmission, or second retransmission.

That is, to configure several groups may have an object of reducing a contention probability, but may also be used as an object for adjusting the success probability of each resource pool.

If a UE selects a specific group as described above, an eNB may perform a resource allocation-related operation in a corresponding group unit.

Accordingly, if it is assumed that the eNB performs the resource allocation-related operation in each group unit, a method for the eNB to allocate a resource to each group may be basically divided into a dynamic resource allocation method and a semi-persistent resources allocation method.

First, the dynamic resource allocation method is a method for an eNB to continue to update a resource allocation configuration at specific time intervals.

In this case, the eNB may notify the UE of the dynamic resource allocation configuration through physical layer signaling or higher layer signaling.

An advantage of the dynamic resource allocation method is that an allocated resource can be changed in accordance with the number of UEs or the expected resources of UEs.

For example, an eNB may previously allocate a maximum contention-PUSCH resource pool to a UE through an SIB and change a configuration so that some of dynamically configured resources are used or all of the dynamically configured resources are used.

That is, if the dynamic resource allocation method is used, a subframe in which a dynamic resource configuration is located is previously configured. A UE trying to use a resource pool needs to listen to a dynamic resource configuration message transmitted by an eNB prior to UL data transmission.

In this case, if the UE does not successfully receive the dynamic resource configuration message, the eNB may fall back to the UE using a resource configured in an SIB.

If such a method is taken into consideration, a method of configuring a minimum resource pool in an SIB and dynamically increasing a resource may be taken into consideration.

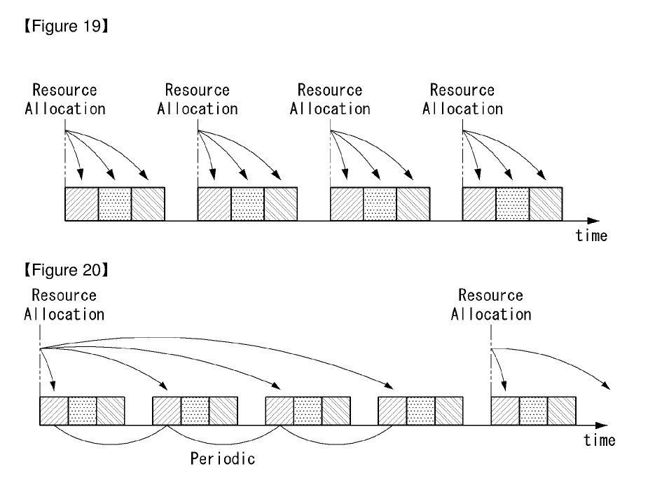

FIG. 19 is a diagram showing an example of the dynamic resource allocation method proposed by this specification.

From FIG. 19, it may be seen that an eNB dynamically change a resource allocation every specific timing.

Next, the semi-persistent resource allocation method refers to a method for an eNB to previously allocate a resource to a UE so that the UE can use the resource in a specific pattern during a specific interval when the eNB notifies the UE of a resource allocation configuration (subsequently).

For example, an MTC UE has a characteristic in that it transmits data at several time intervals or a specific time interval.

In this case, an eNB previously notifies an MTC UE group of a configuration at specific timing so that the MTC UE group can occupy a data transmission channel at several time intervals or a specific time interval.

An eNB may notify a UE of such a semi-persistent resource allocation configuration through an SIB.

FIG. 20 is a diagram showing an example of the semi-persistent resource allocation method proposed by this specification.

A detailed example of the dynamic resource allocation method may include a method using a group-RNTI.

In this case, a UE may detect an UL grant through a group-RNTI.

The group-RNTI detection operation of the UE may be an additional operation in addition to a C-RNTI or may include detecting an UL grant through only a group-RNTI.

In this case, a network or an eNB may configured the group-RNTI to which each UE belongs or the group-RNTI may be determined using information of the UE, such as a UE ID and a coverage class.

Alternatively, the group-RNTI of each UE may be determined using the partial bits of a temporary-RNTI configured in the UE through an RACH procedure.

For example, if a group-RNTI is determined using the partial bits of a temporary-RNTI, it may be defined as in Equation 4.

group−RNTI=floor(temporary C−RNTI/10000)*10000) [Equation 4]

The UL grant allocated as such a group-RNTI may include resource allocation for several resources.

In this case, the amount of resources that belong to the several resources and that may be used by each UE may have been previously configured or may be configured through an UL grant.

An advantage of an UL grant using such a group-RNTI is that UL data can be transmitted without a BSR process when massive UEs generated data sporadically.

The UL grant method using a group-RNTI may be applied to all of UEs in the IDLE state or the CONNECTED state.

For example, an IoT network (or NB-LTE system or NB-IoT system) supporting a narrow band of 200 KHz may be assumed. If subcarrier spacing is 2.5 KHz, a total of 72 subcarriers may be assumed.

In this case, available resources of the resources of the total of 72 subcarriers may be configured through an UL grant. If each UE is capable of transmission using only one subcarrier, the UE may select one of the UL-granted resources and transmit UL data.

Furthermore, it is necessary to make clear how long will a corresponding resource be valid when a contention-based resource pool is configured.

For example, if a contention-based resource pool is transmitted from an eNB to a UE through an SIB, the UE may assume that the corresponding resource pool is valid until a next SIB cycle or may assume that the corresponding resource pool is valid until an SIB is updated.

If the corresponding resource pool is dynamically transmitted, the UE may assume that the corresponding resource pool is valid until it receives next dynamic indication from the eNB.

Furthermore, if the corresponding resource pool is transmitted to the UE through the UL grant of a group-RNTI, the UE may assume that only the corresponding resource pool is valid.

Furthermore, if the UE receives the corresponding resource pool from the eNB through the UL grant of a group-RNTI, it may assume that a coverage class or a repetition number are together configured. Retransmission at retransmission timing or the configuration of a resource for new retransmission through the same resource may be taken into consideration.

In such a case, indication indicating whether the UL grant of the group-RNTI is for initial transmission or for retransmission may be included in the UL grant.

Furthermore, in the resource allocation method using a group RNTI, in order to further reduce a contention between UEs, the range of a UE ID may be indicated.

In this case, the range of the UE ID may indicate the range in which a resource may be used.

Alternatively, an eNB may notify a UE of the qualification condition of the UE on which a corresponding resource may be used through indication.

For example, an eNB may indicate whether a resource is for retransmission or for initial transmission to a UE, or may limit a coverage class for a UE, or may set a limit according to the time during which a scheduling grant is not received.

Alternatively, an eNB may notify a UE of a transmission probability.

Resource Selection Method of UE

A method for a UE to select a resource for transmitting UL data after the UE receives a contention-based PUSCH resource allocated thereto from an eNB or a network is described.

If an eNB allocates a resource in a UE group unit through the aforementioned resource allocation method, it is necessary to determine that which UE will actually occupy a channel and transmit data within the allocated resource.

An MTC UE is an ultra-low complexity and low-cost UE. Accordingly, it is difficult to take into consideration a contention method of sensing a channel as in a communication method in an unlicensed band.

Accordingly, the UE has to randomly select some resources within resources allocated to a group to which the UE belongs.

Even in this case, in order to reduce a transmission collision probability between UEs, an eNB may allocate resources in a UE group unit and configure a detailed resource group within the allocated resources of the UE group unit.

In this case, the UEs may select a detailed resource (group) that will be actually transmitted using their unique IDs, thereby being capable of reducing the transmission collision probability.

For example, the eNB may configure 3 detailed groups, such as {4,5,6,7}, {8,9,10}, and {11,12,13,14,15}, while configuring subcarriers Nos. 4 to 15 in a specific UE group 2.

If a result of modulo operation between the ID of a UE and the detailed groups is “3”, the UE may transmit UL data using {11,12,13,14,15} subcarrier, that is, the third detailed resource group.

Moreover, when the UE selects a specific resource within the detailed resource group, the corresponding UE may select the specific resource randomly or through modulo operation of the ID.

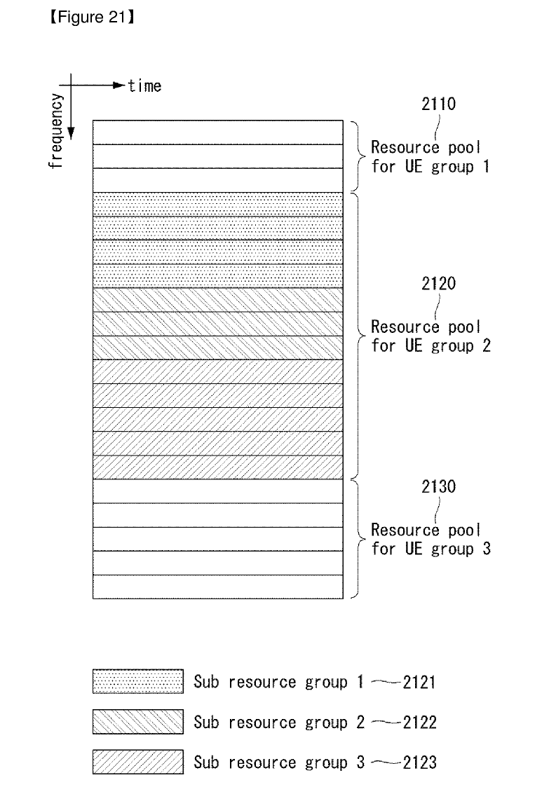

FIG. 21 is a diagram showing an example of resource pool allocation for a specific UE group and detailed resource group allocation proposed by this specification.

From FIG. 21, it may be seen that resource pools 2110, 2120, and 2130 have been configured in 3 UE groups (UE group 1, UE group 2, and UE group 3) in a frequency region.

Furthermore, it may be seen that the resource pool 2120 for the UE group 2 includes 3 sub resource groups (sub resource group 1 2121, sub resource group 2 2122, and sub resource group 3 2123).

Furthermore, an eNB may configure a resource group (for contention-based PUSCH transmission) in the UE and at the same time, may additionally configure one or more demodulation reference signals (DM-RS)/cyclic shifts/orthogonal cover code (OCC) pools.

In this case, when the UE transmits UL data in the allocated resource group, it additionally selects the DM-RS/cyclic shift/OCC within the allocated pool, thereby being capable of further reducing a collision probability.

In this case, a method for the UE to select the DM-RS/cyclic shift/OCC within the allocated DM-RS/cyclic shift/OCC pool may be configured (1) by selecting any one, may be configured (2) by taking into consideration a channel environment, may be configured (3) by using a UE (or user) ID, or (4) by taking into consideration the sequence of a PRACH preamble, transmission timing thereof, and a position on frequency.

To configure a DM-RS/cyclic shift/OCC within a DM-RS/cyclic shift/OCC pool according to a channel environment may be a configuration according to an RSRP measurement value.

Several methods for a UE to select resources (for contention-based PUSCH transmission) may be taken into consideration.

A method for a UE to randomly select a resource may be most common, which increases a selection probability for a successful resource.

If a UE identically configures a resource selected upon initial transmission and a resource selected upon retransmission, a collision may continue to occur.

Accordingly, the UE may always select different resources upon initial transmission and upon retransmission, or may determine a resource selection method in initial transmission and retransmission according to the probability that a different resource is selected.

If a UE continues to fail in the transmission of UL data through a contention-based PUSCH resource (e.g., based on threshold), the UE may attempt common uplink transmission through a PRACH.

Alternatively, if a UE fails in the transmission of UL data through the contention-based PUSCH resource, a back-off concept upon retransmission may be introduced.

In this case, back-off may be a value that increases or decreases whenever retransmission is performed.

Alternatively, if the UL data transmission of a UE fails, a method of ramping up power upon retransmission or increasing a repetition number whenever retransmission is performed as in PRACH transmission may be taken into consideration.

Alternatively, if a resource pool is determined to be a frequency region and a time region, if a repetition number required by a UE is smaller than a set time axis resource, the UE may randomly select the transmission starting occasion of UL data.

That is, if resource blocks of {F, t} are given, a UE may randomly select (f, t) and r (repetition number).

In this case, F indicates a set of subcarriers or resource blocks in the frequency domain, and t indicates a set of subframes in the time domain.

In the case where a UE transmits UL data through a contention-based PUSCH resource through repetition, if an eNB is unaware of the number of repetitions of the UE and the transmission of the UL data starts in a random subframe, the complexity of the eNB (or network) may increase.

Accordingly, when the eNB configures a contention-based PUSCH resource pool for the UE, it may designate a starting occasion for each repetition number.

An example of a method of designating the starting occasion for each repetition number may include a method of dividing T by R corresponding to each repetition number.

In such a case, a set of Rs to be used as a repetition number may be previously set or may be set by the eNB.

When a UE transmits UL data through a resource configured by an eNB through a group-RNTI, a group-RNTI may be used as the sequence of a DM-RS.

Furthermore, a UE ID may be added to the payload of the UL data so that the eNB can be aware that which UE has transmitted the UL data.

If a UE receives a common resource for contention-based PUSCH transmission through an SIB from an eNB and a group has been configured in a corresponding resource, the UE may use a group ID as scrambling upon UL data transmission.

If a group has not been configured in a corresponding resource, a UE may transmit UL data using a cell ID or may transmit UL data using a previously designated cell-specific ID.

The reason why a group ID, cell ID or cell-specific ID is used as described above is to reduce the blind detection (BD) of an eNB or network.

However, a method of differently using scrambling for each repetition level or each coverage class level for blind detection for a repetition level may be taken into consideration.

ACK (A)/NACK (N) for UL data transmission using the aforementioned contention-based PUSCH resource may be downloaded in accordance with A/N timing or an M-PDCCH transmission cycle.

The M-PDCCH means a physical downlink control channel in the NB-LTE system.

If a plurality of (contention-based PUSCH) resources is present, A/N for each resource may be transmitted from an eNB to a UE through common DCI in a bitmap form or individual DCI may be transmitted from an eNB to a UE as a C-RNTI corresponding to each UE.

Alternatively, if A/N is transmitted through common DCI, the common DCI may be transmitted using a group-RNTI again.

In this case, if A/N is transmitted to a UE for each resource, the UE may be aware of information about whether ACK for a corresponding resource is successful in its own transmission or is successful in the transmission of another UE.

That is, when a method of transmitting A/N is used for each resource, it may have an influence on A/N reliability.

Alternatively, a DCI may be transmitted through a group-RNTI, and the DCI may include all of RNTIs whose UL data transmission is successful.

Furthermore, if a UE transmits UL data through a contention-based PUSCH resource, a transport block size (TBS) used by the UE may be selected within a limited set.

The used TBS may be fixed to one, but one or more TBSs may be preferably selected for flexibility.

A UE may take into consideration the following (1) to (4) methods in order to indicate such a TBS.

(1) A selected TBS index is used for the scrambling of a DM-RS or UL data.

Alternatively, the selected TBS index is added to CRC.

Accordingly, a network can be aware of a TBS transmitted by a UE through blind detection (BD).

(2) In order to indicate a selected TBS for an eNB, a UE attaches a preamble or an RS similar to a DM-RS prior to PUSCH transmission and transmits it.

For example, the UE may map a root-sequence to a TBS index in order to indicate or transfer the TBS.

(3) One TB may be divided into a small segment (fixed size) and the remaining segments (variable sizes) and transmitted.

In this case, the small segment of a fixed size may be expressed as a first segment, and the remaining segment of a variable size may be expressed as a second segment.

For example, if a UE carries a TBS and a UE ID on the segment of a fixed size and transmits it (first segment transmission), when the transmission of the first segment is terminated, the UE starts the transmission of the second segment.

Accordingly, an eNB or a network can be aware of a UE ID and the size of a transmission block (TB) through the first segment.

In this case, the size of the first segment can be reduced using a small CRC in the first segment.

Furthermore, it is advantageous to perform contention-based PUSCH transmission through a small message. Accordingly, a method for a UE to always first transmit only a fixed small segment through a contention-based PUSCH resource and to transmit the second segment only when ACK is received from an eNB with respect to the small segment may be taken into consideration.

That is, if such a method is used, a UE may increase a block error rate (BLER) target without considering A/N for the second segment transmission and attempt one-shot transmission.

(4) A segment that is first transmitted may be a preamble of a PRACH form.

In order to include a TBS in the first segment and transmit it, a UE may transmit TBS information in a root-sequence.

In this case, an eNB may notify a UE of A/N regarding whether transmission is successful through a preamble index because the eNB is unaware of a UE ID.

This case may be considered to be the same procedure as a non-contention-based PUSCH that belongs to current RACH procedures and in which a message is transmitted without a contention resolution interval (i.e., the msg3 and msg4 are omitted and a message is transmitted through the msg3 and msg4).

This method may generate a collision when the second segment transmission is performed because a contention of a UE that has transmitted the same preamble is not solved. Since a network finally notifies a UE of an ID included in a message through ACK in such a contention, the UE can be aware of whether transmission has failed or succeeded.

That is, in the RACH procedure, a UE can be aware of whether transmission has failed or succeeded in such a manner that (i) the UE transmits a PRACH preamble to an eNB, (ii) the UE receives a preamble index through an RAR from the eNB, (iii) the UE carries data on Msg 3 and transmits it to the eNB, (iv) the eNB includes a UE ID successful in Msg 4 and transmits it to the UE regarding whether Msg 3 is successful.

In this case, a UE successful in transmission through the (iv) process checks whether there is more data to be transmitted, and shifts to the sleep state if there is no data to be transmitted.

A UE which has failed in transmission through the (iv) process may perform the RACH procedure again.

In the above method, the procedure of Msg3 and Msg4 is performed like a non-contention in the current RACH procedure structure, but the method can be supported because the contents of the Msg3 and Msg 4 are changed.

A TBS may be associated with a resource pool as an additional characteristic in relation to the aforementioned TBS indication.

That is, a (contention-based PUSCH) resource pool may be configured for each TBS in order to support several TBSs.

After selecting a resource pool according to each TBS, a UE may transmit UL data through the selected resource pool.

In this case, the index of the resource pool may be used to transfer the TBS.

Resource Allocation Method for UE not Synchronized

A method of allocating a resource to a UE that has not been synchronized is described below.

In the LTE system, in order for an eNB to receive timing, such as an UL signal, from several UEs, the eNB notifies each UE of a timing advance (TA) value.

The UE transmits data to be transmitted in the uplink at timing that is TA earlier than the timing of downlink reception data using its own TA value.

However, in a system in which UEs are distributed at very high density, the TA value of a UE may not be updated at proper timing.

In such a case, interference may occur in the eNB because UL data is transmitted by the UE at incorrect timing.

Accordingly, (1) a method using CP lengths of several types (Method 1) and (2) a method for an eNB to configure resources (Method 2) are described as a method of allocating resources to UEs that are not synchronized in a high-density UE environment.

Method 1: Method Using Syclic Prefix (CP) Lengths of Several Types

In the case of an environment in which a UE has low mobility, the UE may predict its timing to some extent using the existing TA value.

However, if the TA value of the UE is not updated for a long time, performance of the system may be degraded due to an incorrect TA value.

Furthermore, since a UE that first enters the system or a UE in the idle state does not have a TA value, there is a need for a method for allowing such UEs to immediately access the system at desired timing.

In such a case, UEs are divided into two or more (UE) groups depending on the existing TA value and the period in which a TA value has not been updated. An incorrect part of a TA value may be partially compensated for by differently setting a cyclic prefix (CP) length for each group.

It is assumed that a UE not having the existing TA value belongs to a group having the longest CP length.

An eNB may notify a UE of the group classification of a UE and the classification of an available resource pool for each UE group through physical layer signaling or higher layer signaling.

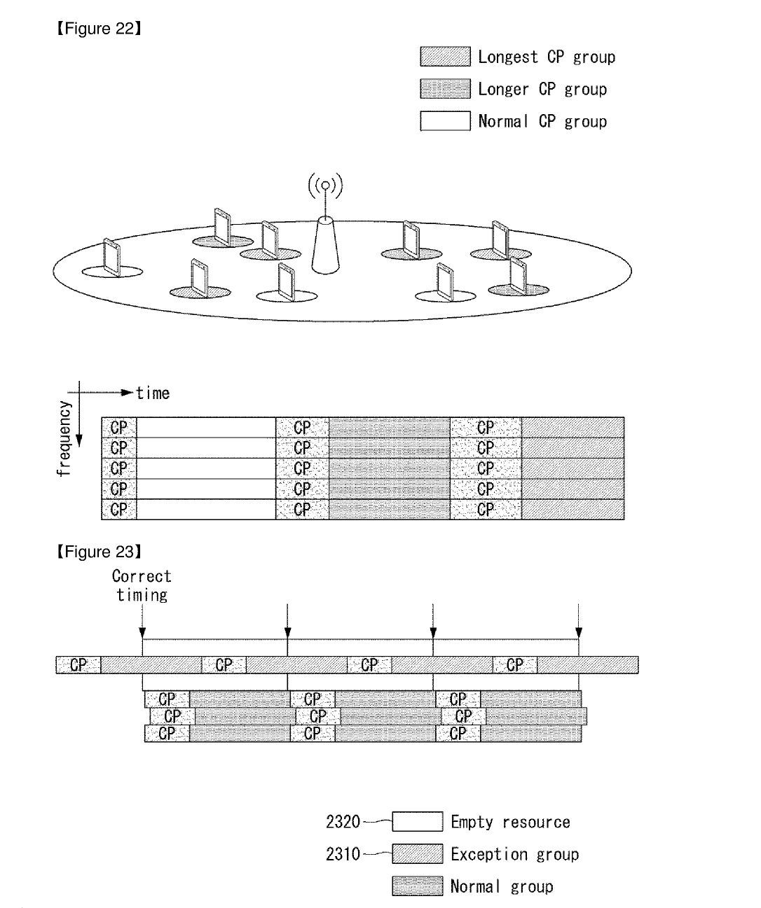

FIG. 22 is a diagram showing an example of a UE group classification according to a CP length and a resource pool configuration for each group proposed by this specification.

More specifically, to differently use CP lengths for a contention-based PUSCH resource and a resource transmitted in a common grant may be taken into consideration.

In this case, a dedicated resource via a pre-grant may be used instead of the resource transmitted in the common grant.

That is, to differently use CP lengths for the contention-based PUSCH resource and the dedicated resource via a pre-grant may be taken into consideration.

A resource differently using a CP length may be a structure that is subjected to TDM or FDM.

Furthermore, if a contention-based PUSCH is used, a TA value may always be assumed to be “0.”

As described above, in a resource structure having a different CP length, a UE may select a specific resource based on the SINR or path-loss of each UE or through a round-trip with an expected eNB.

That is, a network may configure several resource pools having different CP lengths and transmit them to a UE. The UE may select a resource pool most suitable for its own situation.

In this case, if a CP length is increased, an OFDM symbol length may be generally increased. This may mean that the number of OFDM symbols that may be taken into consideration in one transmit time interval (TTI) is reduced.

Accordingly, the number of OFDM symbols in one TTI may be reduced in the interval in which a CP length has been increased.

For example, the number of OFDM symbols in a short CP may be 20, the number of OFDM symbols in a normal CP may be 14, and the number of OFDM symbols in a long CP may be 10.

Furthermore, the interval in which a DM-RS is transmitted may also be changed depending on the length of a CP.

Furthermore, if TTI sizes having the same number of OFDM symbols are taken into consideration, the TTI size may be variably changed depending on a CP length.

A network may perform such a configuration or the configuration may be a previously set value.

Method 2: Method Using Configuration of eNB

Unlike in the method using CP lengths of the aforementioned several types, if the length of a CP is fixed to one, UL transmission timing of a UE may be greatly deviated due to incorrect TA.

In this case, even a CP interval in a neighbor tone is exceeded, generating mutual interference with the signals of neighbor tones. As a result, performance of a system may be greatly degraded.

Accordingly, in order to solve interference with the signals of neighbor tones, when an eNB allocates a resource to a UE group, in TA, a configuration may be performed so that the neighbor tone of a resource used by an incorrect UE group is made empty.

FIG. 23 is a diagram showing an example in which a resource neighboring a resource used by a UE group whose TA is incorrect is reserved, which is proposed by this specification.

From FIG. 23, it may be seen that in TA, a resource used by an incorrect UE group, that is, the neighboring resource (or neighbor tone) of an exception group 2310 has been configured as an empty resource 2320.

As described above, an eNB may notify a UE of a UE group classification and the classification of an available resource pool for each group through physical layer signaling or higher layer signaling.

Alternatively, if an eNB allocates a contention-based PUSCH resource for a UE through a specific subcarrier or a specific frequency resource, it may previously designate an automatically set value to the UE.

In this case, the automatically set value may indicate a resource region allocated to the UE.

Furthermore, a contention-based PUSCH resource and a grant-based resource (resource through an UL grant) may be configured according to the FDM method so that the UE can effectively use the contention-based PUSCH resource.

In such a case, the contention-based PUSCH resource and the grant-based resource (resource through an UL grant) are not designated through specific signaling, such as an SIB, but may be configured so that the resources are always configured.

For example, one subcarrier (near an edge) may be allocated as a contention-based PUSCH and a corresponding resource may be configured according to the TDM method for each coverage class.

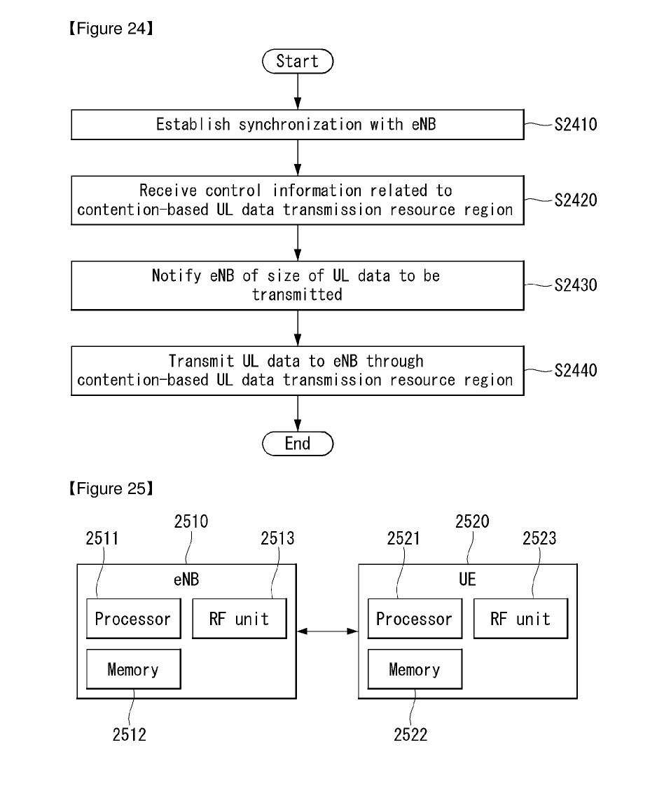

FIG. 24 is a flowchart showing an example of an uplink data transmission method of a UE proposed by this specification.

First, the UE sets up synchronization with an eNB (S2410).

Thereafter, the UE receives control information related to a contention-based uplink data transmission resource region from the eNB (S2420).

In this case, the contention-based uplink data transmission resource region may include one or more resource groups.

Furthermore, the resource groups may be resource groups allocated for each UE group based on a specific criterion.

The specific criterion may be at least one of the identity of the UE or the coverage class of the UE.

Furthermore, the resource groups may be classified according to a cyclic prefix (CP) length.

If the UE is not synchronized with the eNB, the UE may select a resource group that belongs to resource groups and that corresponds to a long CP length, and may transmit uplink data.

Alternatively, if the UE is not synchronized with the eNB, the eNB may not allocate a resource for another UE to a neighboring resource of a resource group allocated to the UE.

Furthermore, the contention-based uplink data transmission resource region may be a narrowband including a plurality of subcarriers having specific subcarrier spacing.

Furthermore, the control information may be transmitted through at least one of a group-RNTI and a C-RNTI.

Thereafter, the UE notifies the eNB of the size of uplink data to be transmitted (S2430).

The UE may perform the transmission of the size of the uplink data to be transmitted along with the transmission of the uplink data.

Furthermore, the uplink data may include a first segment and a second segment.

The first segment may indicate a small data part of a fixed size, and the second segment may indicate the remaining data part of a variable size.

The size of the uplink data to be transmitted may be included in the first segment.

Furthermore, the eNB may allocate the one or more resource groups to the UE dynamically or semi-statically.

Thereafter, the UE transmits the uplink data to the eNB through the contention-based uplink data transmission resource region (S2440).

Specifically, in the transmission of the uplink data, the UE may select any one of the resource groups and transmit the uplink data to the eNB through the selected resource group.

In this case, the UE may select any one resource group by taking into consideration the size of the uplink data to be transmitted.

Furthermore, in order to notify the eNB of the size of the uplink data to be transmitted, the UE may transmit a root-sequence mapped to an index indicative of the size of the uplink data to be transmitted to the eNB.

The root-sequence may be transmitted prior to the uplink data transmission.

The UE may transmit the root-sequence or the uplink data to the eNB by scrambling them using an index.

Furthermore, the UE may receive acknowledgement (ACK) or non-acknowledgement (NACK) for the uplink data from the eNB after the uplink data transmission.

In this case, the ACK or the NACK may be received from the eNB for each resource group.

Furthermore, after transmitting the uplink data, the UE may switch from the connected state to an idle state.

In this case, the eNB does not release a cell-radio network temporary identifier (C-RNTI) allocated to the UE.

General Apparatus to which the Present Invention may be applied

FIG. 25 shows an example of an internal block diagram of a wireless communication apparatus to which the methods proposed by this specification may be applied.

Referring to FIG. 25, the wireless communication system includes an eNB 2510 and a plurality of UEs 2520 located within the eNB 2510 region.

The eNB 2510 includes a processor 2511, memory 2512 and a radio frequency (RF) unit 2513. The processor 2511 implements the functions, processes and/or methods proposed by FIGS. 1 to 24. The layers of a radio interface protocol may be implemented by the processor 2511. The memory 2512 is connected to the processor 2511 and stores various types of information for driving the processor 2511. The RF unit 2513 is connected to the processor 2511 and transmits and/or receives a radio signal.

The UE 2520 includes a processor 2521, memory 2522 and an RF unit 2523. The processor 2521 implements the functions, processes and/or methods proposed by FIGS. 1 to 24. The layers of a radio interface protocol may be implemented by the processor 2521. The memory 2522 is connected to the processor 2521 and stores various types of information for driving the processor 2521. The RF unit 2523 is connected to the processor 2521 and transmits and/or receives a radio signal.

The memory 2512, 2522 may be located inside or outside the processor 2511, 2521 and may be connected to the processor 2511, 2521 by well-known various means.

Furthermore, the eNB 2510 and/or the UE 2520 may have a single antenna or multiple antennas.

In the aforementioned embodiments, the elements and characteristics of the present invention have been combined in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present invention. Order of the operations described in the embodiments of the present invention may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present invention may be implemented by various means, for example, hardware, firmware, software or a combination of them. In the case of an implementation by hardware, the embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present invention may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

The method of transmitting a random access signal in a wireless communication system of this specification has been illustrated based on an example in which the method is applied to the 3GPP LTE/LTE-A systems, but may be applied to various wireless communication systems, such as the 5G system, in addition to the 3GPP LTE/LTE-A systems.

1. A method of transmitting uplink data in a wireless communication system, the method performed by an user equipment (UE) comprising:
establishing synchronization with an evolved Node B (eNB);
receiving control information related to a contention-based uplink data transmission resource region from the eNB, the contention-based uplink data transmission resource region comprising one or more resource groups;
notifying the eNB of a size of uplink data to be transmitted; and
transmitting the uplink data to the eNB through the contention-based uplink data transmission resource region.

2. The method of claim 1, wherein the resource groups are resource groups allocated for each UE group based on a specific criterion.

3. The method of claim 2, wherein the specific criterion is at least one of an identity of the UE or a coverage class of the UE.

4. The method of claim 1, wherein the transmitting the uplink data comprising:
selecting any one of the resource groups; and
transmitting the uplink data to the eNB through the selected resource group.

5. The method of claim 4, wherein the selecting the any one resource group comprising:
selecting any one resource group by taking into consideration the size of the uplink data to be transmitted.

6. The method of claim 1, wherein the notifying the size of uplink data to be transmitted comprising:
transmitting a root-sequence mapped to an index indicative of the size of the uplink data to be transmitted to the eNB.

7. The method of claim 6, wherein the root-sequence is transmitted prior to the uplink data transmission.

8. The method of claim 6, wherein the root-sequence or the uplink data is scrambled by the index.

9. The method of claim 1, wherein the notifying the size of uplink data to be transmitted is performed along with the transmission of the uplink data.

10. The method of claim 9, wherein:
the uplink data comprises a first segment and a second segment, and
the size of the uplink data to be transmitted is included in the first segment.

11. The method of claim 1, wherein the one or more resource groups are allocated dynamically or semi-statically.

12. The method of claim 1, further comprising:
receiving acknowledgement (ACK) or non-acknowledgement (NACK) for the uplink data from the eNB, wherein the ACK or the NACK is received for each resource group.

13. The method of claim 1, further comprising:
switching to an idle state, wherein a cell-radio network temporary identifier (C-RNTI) allocated by the eNB is not released.

14. The method of claim 4, wherein:
the resource groups are classified according to a cyclic prefix (CP) length, and
if the UE is not synchronized with the eNB, a resource group belonging to the resource groups and corresponding to a long CP length is selected.

15. The method of claim 4, wherein if the UE is not synchronized with the eNB, a resource for another UE is not allocated to a neighboring resource of the selected resource group.

16. The method of claim 1, wherein the contention-based uplink data transmission resource region is a narrowband comprising a plurality of subcarriers having specific subcarrier spacing.

17. The method of claim 1, wherein the control information is received from the eNB through at least one of a group-RNTI and a C-RNTI.

18. An user equipment (UE) for transmitting uplink data in a wireless communication system, the UE comprising:
a radio frequency (RF) unit for transmitting or receiving a radio signal; and
a processor functionally connected to the RF unit,
wherein the processor is configured to:
establish synchronization with an evolved Node B (eNB);
receive control information related to a contention-based uplink data transmission resource region from the eNB, the contention-based uplink data transmission resource region comprising one or more resource groups;
notify the eNB of a size of uplink data to be transmitted; and
transmit the uplink data to the eNB through the contention-based uplink data transmission resource region.
